(19) United States
(12) Patent Application Publication
(10) Pub. No.: US 2013/0274425 A1
(43) Pub. Date: Oct. 17, 2013

(54) Methods To Increase Oligomer Viscosity And Uses Thereof

(71) Applicants: Matthew W. Holtcamp, Huffman, TX (US); Donna J. Crowther, Seabrook, TX (US); Caol P. Huff, Houston, TX (US); Patrick Brant, Seabrook, TX (US)

(72) Inventors: Matthew W. Holtcamp, Huffman, TX (US); Donna J. Crowther, Seabrook, TX (US); Caol P. Huff, Houston, TX (US); Patrick Brant, Seabrook, TX (US)

(21) Appl. No.: 13/446,145

(22) Filed: Apr. 13, 2012

(51) Int. Cl. C08F 4/18; C08F 4/10; C08F 4/12; C08F 4/24; C08F 4/20; C08F 2/01; C08F 4/26

(52) U.S. Cl. 526/68; 526/89; 526/95; 526/101; 526/103; 526/104; 526/130; 526/183; 526/194; 526/195; 526/221; 526/226

(57) ABSTRACT

This invention relates to processes for increasing the viscosity of an oligomer composition including contacting the oligomer composition comprising one or more vinyl terminated oligomer with a supported mixed metal oxide catalyst; wherein the contacting causes the reaction of the vinyl terminated oligomers; and producing a product oligomer composition having a higher viscosity than the oligomer composition.

### STATEMENT OF RELATED CASES

This application relates to U.S. Ser. No. 12/143,663, filed on Jun. 20, 2008 (published as US 2009/0318644); U.S. Ser. No. 12/487,739, filed on Jun. 19, 2009 (published as US 2009/0318646); U.S. Ser. No. 12/488,066, filed on Jun. 19, 2009 (published as US 2009/0318640); Ser. No. 12/488,093 filed on Jun. 19, 2009 (published as US 2009/0318647); U.S. Ser. No. 13/072,288, filed on Mar. 25, 2011 (published as US ______); U.S. Ser. No. 13/072,249, filed on Mar. 25, 2011 (published as US ______); and U.S. Ser. No. 12/642,453, filed Dec. 18, 2009 (published as US 2010/0170829); which is a continuation-in-part application of U.S. Ser. No. 12/533,465 filed on Jul. 31, 2009 (published as US 2010/0038290); which claims priority to and the benefit of U.S. Ser. No. 61/136,172, filed on Aug. 15, 2008; which are all incorporated by reference herein.

### FIELD OF THE INVENTION

This invention relates to methods to improve oligomer properties and uses thereof.

### BACKGROUND OF THE INVENTION

Low molecular weight polymers have historically been undesirable byproducts of polymerization processes. The presence of these low molecular weight compounds adversely affected the polymerization process because it decreased the yield of the desired product, and very often, these byproducts had no commercial value. However, oligomers and low molecular-weight polymers have found widespread application in the petrochemical industry, cosmetics industry, food industry, and in polymer production. For example, low molecular weight polymers have demonstrated utility as additives for fuels and lubes, and as coatings and adhesive additives. Efforts are therefore currently being exerted to produce such low molecular weight polymers, particularly those that can be modified post-reactor, such as alpha-olefins.

Alpha-olefins, especially those containing about 6 to about 20 carbon atoms, have been used as intermediates in the manufacture of detergents or other types of commercial products. Such alpha-olefins have also been used as comonomers, especially in linear low density polyethylene. Commercially produced alpha-olefins are typically made by oligomerizing ethylene. Longer chain alpha-olefins, such as vinyl-terminated polyethylenes, are also known and can be useful as building blocks following functionalization or as macromonomers.

Allyl terminated low molecular weight solids and liquids of ethylene or propylene have also been produced, typically for use as branches in polymerization reactions. See, for example, Rulhoff, Sascha, and Kaminsky, “Synthesis and Characterization of Defined Branched Poly(propylene)s with Different Microstructures by Copolymerization of Propylene and Linear Ethylene Oligomers (Cₙ=26-28) with Metallocenes/MAO Catalysts,” Macromolecules, 16, 2006, pp. 1450-1460; Kaneyoshi, Hiromu et al., “Synthesis of Block and Graft Copolymers with Linear Polyethylene Segments by Combination of Degenerative Transfer Coordination Polymerization and Atom Transfer Radical Polymerization,” Macromolecules, 38, 2005, pp. 5425-5435; U.S. Pat. No. 4,814,540; Eshuis et al., J. Mol. Catal., 62, 1990, pp. 277-287; X. Yang et al., Angew. Chem. Intl. Ed. Engl., 31, 1992, pg. 1375; Small and Brookhart, Macromolecules, 32, 1999, pg. 2120-2130; Weng et al., Macromol Rapid Comm. 2000, 21, pp. 1103-1107; Markel et al., Macromolecules, 33, 2000, pp. 8541-8548; Moscardi et al., Organometallics, 20, 2001, pg. 1918; Coates et al., Macromolecules, 38, 2005, pg. 6259; JP 2005-336092 A2; and Rose et al., Macromolecules, 41, 2008, pp. 559-567.

However, most processes to produce low molecular weight polymers often produce, as byproducts, even lower molecular weight products, in addition to the desired product, as part of the product composition. This contributes to process inefficiency because it decreases the yield of the desired low molecular weight polymer product, lowers the molecular weight of the product composition, broadens the molecular weight distribution, and lowers the viscosity of the product composition. Very often these lower molecular weight byproducts are separated from the desired polymer and discarded in order to improve the properties of the polymer composition.

There exists a need to improve the efficiency of processes to produce oligomers and low molecular weight polyolefins. There also exists a need for processes to increase the average molecular weight of an oligomer or low molecular weight polymer composition. There also exists a need for processes to increase the viscosity of an oligomer or low molecular weight polymer composition.

### SUMMARY OF THE INVENTION

This invention relates to processes for increasing the viscosity of an oligomer composition by: contacting the oligomer composition comprising one or more vinyl terminated oligomers with a supported mixed metal oxide catalyst; wherein the contacting causes the reaction of the vinyl terminated oligomers; and producing a product having a higher viscosity, measured at 40° C., than the oligomer composition.

This process also relates to an integrated process comprising: (i) obtaining a recycle stream comprising one or more vinyl terminated oligomers having a Mn (¹H NMR) of about 150 to about 30,000 g/mol; (ii) contacting the oligomer composition comprising one or more vinyl terminated oligomers with a supported mixed metal oxide catalyst; wherein the contacting causes the reaction of the vinyl terminated oligomers; and (iii) obtaining a product having: (1) an Mn (¹H NMR) of about 300 to about 60,000 g/mol, (2) a higher viscosity than the oligomer composition, (3) 0% allyl chain ends, and (4) at least one unsaturation internal to the backbone.

### BRIEF DESCRIPTION OF THE FIGURES

FIG. 1 shows a comparison of the ¹H NMR spectra of the propylene/hexene metathesis product of Example 2 (top) and the propylene/hexane oligomer starting material of Example 1 (bottom).

FIG. 2 shows a comparison of the ¹H NMR spectra of the C₁₅ metathesis product (top) and the C₁₅ oligomer starting material (bottom) of Example 3.

FIG. 3 is a plot of the Brookfield Viscosity (y axis) versus Temperature (x axis) for Example 3. The top line represents the C₁₅ metathesis product, while the bottom line represents the C₁₅ oligomer starting material.

### DETAILED DESCRIPTION

The inventors have surprisingly found new processes to improve the viscosity of oligomer compositions comprising vinyl terminated oligomers as described herein, for example, vinyl terminated macromonomers. The inventors have discovered that the molecular weight of compositions having undesirably low molecular weight, such as vinyl terminated polymers, may be improved by contacting the composition with a supported mixed metal oxide catalyst. Without wishing to be bound by theory, the inventors suggest that the vinyl terminated oligomers undergo self metathesis to produce polymers having an increased molecular weight. The increased molecular weight may be monitored by a concurrent increase in viscosity.

Accordingly, embodiments of the present invention relate to processes for increasing the viscosity of an oligomer composition by contacting the oligomer composition comprising one or more vinyl terminated oligomer with a supported mixed metal oxide catalyst; wherein the contacting causes the reaction of the vinyl terminated oligomers; and producing a product having a higher viscosity than the oligomer composition.

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, including, but not limited to, ethylene, propylene, and butene, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer.

“Higher olefin,” as used herein, means C₄ to C₄₀ olefins; preferably, C₅ to C₃₀ alpha-olefins; more preferably, C₅-C₂₀ alpha-olefins; or even more preferably, C₅-C₁₂ alpha-olefins. A “higher olefin copolymer” is a polymer comprising two or more different monomer units (where different means the monomer units differ by at least one atom or are different isomerically), at least one of which is a higher olefin monomer unit.

A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” as used to refer to mer units indicates that the mer units differ from each other by at least one atom or are different isomerically. Accordingly, the definition of copolymer, as used herein, includes terpolymers and the like. For purposes herein, a “polymer chain” or “polymeric chain” comprises a concatenation of carbon atoms bonded to each other in a linear or a branched chain, which is referred to herein as the backbone of the polymer (e.g., polyethylene). The polymeric chain may further comprise various pendent groups attached to the polymer backbone which were present on the monomers from which the polymer was produced. These pendent groups are not to be confused with branching of the polymer backbone, the difference between pendent side chains and both short and long chain branching being readily understood by one of skill in the art.

An “oligomer” is a polymer having a low molecular weight. In some embodiments, an oligomer has an Mn of 21,000 g/mol or less (e.g., 2,500 g/mol or less); in other embodiments, an oligomer has a low number of mer units (such as 75 mer units or less).

An “alpha-olefin” is an olefin having a double bond at the alpha (or 1-) position, and for purposes of this invention, includes ethylene. A “linear alpha-olefin” or “LAO” is an olefin with a double bond at the alpha position and a linear hydrocarbon chain. A “polyalphaolefin” or “PAO” is a polymer comprising alpha-olefins. For the purposes of this disclosure, the term “α-olefin” includes C₂-C₂₀ olefins. Non-limiting examples of α-olefins include ethylene, propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 1-heneicosene, 1-docosene, 1-tricosene, 1-tetracosene, 1-pentacosene, 1-hexacosene, 1-heptacosene, 1-octacosene, 1-nonacosene, 1-triacontene, 4-methyl-1-pentene, 3-methyl-1-pentene, 5-methyl-1-nonene, 3,5,5-trimethyl-1-hexene, vinylcyclohexane, and vinylnorbornane.

The term “substituted” means that a hydrogen group has been replaced with a hydrocarbyl group, a heteroatom, or a heteroatom containing group. For example, methyl cyclopentadiene (Cp) is a Cp group substituted with a methyl group and ethyl alcohol is an ethyl group substituted with an —OH group.

An ethylene polymer is a polymer having at least 50 mol % ethylene, a propylene polymer is a polymer having at least 50 mol % of propylene, and so on.

As used herein, Mn is number average molecular weight as determined by proton nuclear magnetic resonance spectroscopy (¹H NMR) unless stated otherwise, Mw is weight average molecular weight as determined by gel permeation chromatography (GPC), Mz is z average molecular weight as determined by GPC, wt % is weight percent, and mol % is mole percent. Molecular weight distribution (MWD) is defined to be Mw divided by Mn. Unless otherwise noted, all molecular weight units, e.g., Mw, Mn, Mz, are reported in units of g/mol.

For the purposes of this invention and the claims thereto, the new numbering scheme for the Periodic Table Groups is used as set out in CHEMICAL AND ENGINEERING NEWS, 63(5), pg. 27 (1985). Therefore, a “Group 4 metal” is an element from Group 4 of the Periodic Table.

The terms “catalyst” and “catalyst compound” are defined to mean a compound capable of initiating catalysis. In the description herein, the catalyst may be described as a catalyst precursor, a pre-catalyst compound, or a transition metal compound, and these terms are used interchangeably. A catalyst compound may be used by itself to initiate catalysis or may be used in combination with an activator to initiate catalysis. When the catalyst compound is combined with an activator to initiate catalysis, the catalyst compound is often referred to as a pre-catalyst or catalyst precursor. A “catalyst system” is a combination of at least one catalyst compound, an optional activator, an optional co-activator, and an optional support material, where the system can polymerize monomers to polymer. Typically a catalyst system comprises at least a catalyst compound and an activator. For the purposes of this invention and the claims thereto, when catalyst systems are described as comprising neutral stable forms of the components, it is well understood by one of ordinary skill in the art, that the ionic form of the component is the form that reacts with the monomers to produce polymers.

An “anionic ligand” is a negatively charged ligand which donates one or more pairs of electrons to a metal ion. A “neutral donor ligand” is a neutrally charged ligand which donates one or more pairs of electrons to a metal ion.

A “scavenger” is a compound that is typically added to facilitate oligomerization or polymerization by scavenging impurities. Some scavengers may also act as activators and may be referred to as co-activators. A co-activator, that is not a scavenger, may also be used in conjunction with an activator in order to form an active catalyst. In some embodiments, a co-activator can be pre-mixed with the catalyst compound to form an alkylated catalyst compound.

The terms “hydrocarbyl radical,” “hydrocarbyl,” and “hydrocarbyl group” are used interchangeably throughout this document. Likewise, the terms “functional group,” “group,” and “substituent” are also used interchangeably in this document. For purposes of this disclosure, “hydrocarbyl radical” is defined to be C₁ to C₂₀ radicals, that may be linear, branched, or cyclic (aromatic or non-aromatic); and may include substituted hydrocarbyl radicals as defined herein. In an embodiment, a functional group may comprise a hydrocarbyl radical, a substituted hydrocarbyl radical, or a combination thereof.

“Substituted hydrocarbyl radicals” are radicals in which at least one hydrogen atom has been substituted with a heteroatom or heteroatom containing group, or with atoms from Groups 13, 14, 15, 16, and 17 of the Periodic Table of Elements, or a combination thereof, or with at least one functional group, such as halogen (Cl, Br, I, F), NR*₂, OR*, SeR*, TeR*, PR*₂, AsR*₂, SbR*₂, SR*, BR*₂, SiR*₃, GeR*₃, SnR*₃, PbR*₃, and the like or where at least one heteroatom has been inserted within the hydrocarbyl radical, such as halogen (Cl, Br, I, F), O, S, Se, Te, NR*, PR*, AsR*, SbR*, BR*, SiR*₂, GeR*₂, SnR*₂, PbR*₂, and the like, where R* is, independently, hydrogen or a hydrocarbyl radical, or any combination thereof.

In an embodiment, the hydrocarbyl radical is independently selected from methyl, ethyl, ethenyl, and isomers of propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, propenyl, butenyl, pentenyl, hexenyl, heptenyl, octenyl, nonenyl, decenyl, undecenyl, dodecenyl, tridecenyl, tetradecenyl, pentadecenyl, hexadecenyl, heptadecenyl, octadecenyl, nonadecenyl, eicosenyl, heneicosenyl, docosenyl, tricosenyl, tetracosenyl, pentacosenyl, hexacosenyl, heptacosenyl, octacosenyl, nonacosenyl, triacontenyl, propynyl, butynyl, pentynyl, hexynyl, heptynyl, octynyl, nonynyl, decynyl, undecynyl, dodecynyl, tridecynyl, tetradecynyl, pentadecynyl, hexadecynyl, heptadecynyl, octadecynyl, nonadecynyl, eicosynyl, heneicosynyl, docosynyl, tricosynyl, tetracosynyl, pentacosynyl, hexacosynyl, heptacosynyl, octacosynyl, nonacosynyl, and triacontynyl. Also included are isomers of saturated, partially unsaturated, and aromatic cyclic structures wherein the radical may additionally be subjected to the types of substitutions described above. Examples include phenyl, methylphenyl, benzyl, methylbenzyl, naphthyl, cyclohexyl, cyclohexenyl, methylcyclohexyl, and the like. For this disclosure, when a radical is listed, it indicates that radical type and all other radicals formed when that radical type is subjected to the substitutions defined above. Alkyl, alkenyl, and alkynyl radicals listed include all isomers including, where appropriate, cyclic isomers, for example, butyl includes n-butyl, 2-methylpropyl, 1-methylpropyl, tert-butyl, and cyclobutyl (and analogous substituted cyclopropyls); pentyl includes n-pentyl, cyclopentyl, 1-methylbutyl, 2-methylbutyl, 3-methylbutyl, 1-ethylpropyl, and neopentyl (analogous substituted cyclobutyls and cyclopropyls); and butenyl includes E and Z forms of 1-butenyl, 2-butenyl, 3-butenyl, 1-methyl-1-propenyl, 1-methyl-2-propenyl, 2-methyl-1-propenyl, and 2-methyl-2-propenyl (cyclobutenyls and cyclopropenyls). Cyclic compounds having substitutions include all isomer forms, for example, methylphenyl would include ortho-methylphenyl, meta-methylphenyl, and para-methylphenyl; dimethylphenyl would include 2,3-dimethylphenyl, 2,4-dimethylphenyl, 2,5-dimethylphenyl, 2,6-diphenylmethyl, 3,4-dimethylphenyl, and 3,5-dimethylphenyl.

The following abbreviations may be used throughout this specification: Me is methyl, Ph is phenyl, Et is ethyl, Pr is propyl, iPr is isopropyl, n-Pr is normal propyl, Bu is butyl, iBu is isobutyl, tBu is tertiary butyl, p-tBu is para-tertiary butyl, nBu is normal butyl, TMS is trimethylsilyl, TIBAL is triisobutylaluminum, TNOAL is triisobutyl n-octylaluminum, MAO is methylalumoxane, pMe is para-methyl, Ar* is 2,6-diisopropylaryl, Bz is benzyl, THF is tetrahydrofuran, RT is room temperature which is defined as 25° C. unless otherwise specified, and tol is toluene.

### Processes for Increasing Viscosity

Embodiments of the present invention relate to processes for increasing the viscosity of an oligomer composition by contacting the oligomer composition comprising one or more vinyl terminated oligomers with a supported mixed metal oxide catalyst; wherein the contacting causes the reaction of the vinyl terminated oligomers; and producing a product having a higher viscosity than the oligomer composition.

In embodiments herein, an oligomer composition comprising one or more vinyl terminated oligomers is contacted with a supported mixed metal oxide catalyst. Supported mixed metal oxide catalysts, oligomer compositions and vinyl terminated oligomers, useful herein are described in turn, below. The contacting causes the reaction of the vinyl terminated oligomers to produce a product oligomer composition having, among other properties, a higher viscosity than the oligomer composition.

Without wishing to be bound by theory, the inventors surmise that the contacting in the presence of the supported mixed metal oxide catalyst causes the vinyl terminated oligomers to undergo self metathesis to produce a metathesis product, as illustrated by the following reaction scheme.

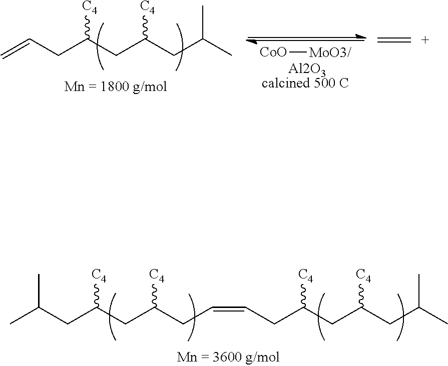

In the above scheme, a vinyl terminated oligomer having C₄ side chains attached to the polymer backbone and a Mn of 1800 g/mol was, at a temperature of 150° C., contacted with a CoO—MoO₃/Al2O₃ catalyst which was calcined. The product has a Mn of 3600 g/mol, has 0% allyl chain ends, and has an unsaturation internal to the backbone. The above scheme is a diagrammatic representation, and as such, the wavy bonds are not intended to confer tacticity, but merely to indicate the C₄ side chains attached to the oligomer backbone.

The contacting produces a product having a higher viscosity than the starting oligomer composition. For the purpose of the claims, the viscosity is measured at about 40° C. In some embodiments, the viscosity of the product is at least 5% higher than the viscosity of the oligomer composition (preferably at least 15%, 25%, 50%, 75%, or 85% higher). Viscosity measurements are made using a Brookfield digital viscometer. The Brookfield digital viscometer measures the viscosity of liquids at elevated temperature by rotating a sensing element in a fluid and measure the torque necessary to overcome the viscous resistance to the induced movement. This is accomplished by driving a spindle, immersed in the fluid, through a beryllium copper spring. The degree to which the spring is wound, detected by a rotational transducer, is proportional to the viscosity of the fluid. The temperature is controlled by a solid state, triac output, proportioning controller which maintains the spindle, chamber, and sample material at a desired temperature. The system is designed for measuring liquid viscosity over a temperature range of up to 300° C. The low limit of temperature control is 15° C. above ambient temperature. In the Examples, the viscosity is reported at about 40° C., 50° C., and 60° C.

In embodiments herein, the contacting produces a product having a higher Mn than the starting oligomer composition. In preferred embodiments, the product has an Mn that is about 1.8 to 2.2 times (preferably 2.0 times) that of the starting oligomer composition.

In some embodiments, the contacting produces a product having a lower (also referred to as “narrow or more narrow”) molecular weight distribution than that of the starting oligomer composition, preferably as measured by GPC. “Molecular weight distribution” (or MWD) which means the ratio of Mw to number average molecular weight (Mn) or Mw/Mn, where both Mw and Mn are determined by GPC. In any embodiment of the invention, the oligomer composition may have a Mw/Mn in the range of from 1.5 to 20 (preferably from 1.7 to 10, more preferably from 1.7 to 5). In any embodiment of the invention, the product MWD is in the range of from about 1.1 to about 2.5 (preferably about 1.1 to 2.0, and more preferably about 1.1 to 1.5).

In some embodiments, the contacting step may occur in the presence of heat, for a time period appropriate to yield the desired metathesis product. The reaction may occur faster in such embodiments. The contacting process may occur at a temperature of 20° C. to 300° C. (preferably 20° C. to 200° C., preferably 20° C. to 150° C., preferably 25° C. to 100° C., preferably 30° C. to 85° C.) for a contacting time of 0.5 seconds to 96 hours (preferably 0.25 to 72 hours, preferably 30 minutes to 24 hours).

In some embodiments, the contacting step may occur at a pressure of 0.1 psig to 1000 psi (0.7 kPa to 6.9 MPa) (preferably 20 psi to 400 psi (0.14 MPa to 2.8 MPa), preferably 50 psi to 250 psi (0.34 MPa to 1.7 MPa)).

In a preferred embodiment, the reactants (for example, supported mixed metal oxide catalyst, oligomer composition, optional diluent, etc.) are combined in a reaction vessel at a temperature of 20° C. to 300° C. (preferably 20° C. to 200° C., preferably 30° C. to 100° C., preferably 40° C. to 60° C.) with a vinyl terminated oligomer composition at a pressure of 0.1 psig to 1000 psi (0.7 kPa to 6.9 MPa) (preferably 20 psi to 400 psi (0.14 MPa to 2.8 MPa), preferably 50 psi to 250 psi (0.34 MPa to 1.7 MPa)), for a residence time of 0.5 seconds to 96 hours (preferably 0.25 to 72 hours, preferably 30 minutes to 24 hours).

The contacting step occurs in the presence of a supported mixed metal oxide catalyst. Any amount of supported mixed metal oxide catalyst may be used, as long as the desired metathesis reaction occurs. In a preferred embodiment, the catalyst is present at from 0.001 nanomoles of transition metal per mole of vinyl terminated oligomer composition to 1 millimoles of transition metal per mole of vinyl terminated oligomer composition. Alternately, the catalyst is present at from 0.01 nanomoles of transition metal per mole of vinyl terminated oligomer composition to 0.1 millimoles of transition metal per mole of vinyl terminated oligomer composition, alternately from 0.1 nanomoles of transition metal per mole of vinyl terminated oligomer composition to 0.075 millimoles of transition metal per mole of vinyl terminated oligomer composition, based upon the moles of vinyl terminated oligomer composition feed into the reactor.

In some embodiments, the catalyst compound is contacted with an activator, before or after the catalyst compound is contacted with the oligomer composition. Preferably, the activator is an alkyltin compound.

The minimum activator-to-transition metal (transition metal of the supported mixed metal oxide catalyst) ratio is typically a 1:1 molar ratio. Alternate preferred ratios include up to 5000:1, preferably up to 500:1, preferably up to 200:1, preferably up to 100:1, or preferably from 1:1 to 50:1. In some embodiments, no activator is used.

The contacting may take place in any vessel or reactor. A “reactor” is any container(s) in which a chemical reaction occurs. The process may be batch, semi-batch, or continuous. As used herein, the term continuous means a system that operates without interruption or cessation. For example, a continuous process to produce a metathesis product would be one where the reactants are continually introduced into one or more reactors and metathesis products are continually withdrawn.

The processes may be conducted in any of glass lined, stainless steel, or similar type reaction equipment. Useful reaction vessels include reactors (including continuous stirred tank reactors, batch reactors, reactive extruder, pipe, or pump, continuous flow fixed bed reactors, slurry reactors, fluidized bed reactors, and catalytic distillation reactors). The reaction zone may be fitted with one or more internal and/or external heat exchanger(s) in order to control temperature fluctuations.

### Supported Mixed Metal Oxide Catalysts

In embodiments herein, supported mixed metal catalysts are useful. Supported mixed metal catalyst, as used herein, refer to two or more metal oxides supported on the same support material.

In preferred embodiments, the supported mixed metal oxide catalyst comprises two or more of cobalt oxide, a molybdenum oxide, rhenium oxide, tungsten oxide, vanadium oxide, boron oxide, and a mixture thereof. In particular embodiments, the supported mixed metal oxide catalyst comprises one or more of CoO/MoO₃, Re₂O₇/Al₂O₃, Re₂O₇/SiO₂/Al₂O₃, Re₂O₇/Al₂O₃/V₂O₅, WO₃/MgO, and WO₃/SiO₂. In preferred embodiments, the supported mixed metal oxide catalyst is CoO/MoO₃. In some embodiments, the supported mixed metal oxide catalyst comprises at least 5% mixed metal oxides (preferably at least 10%, at least 15%, at least 18%, at least 20%), based on the weight of the supported mixed metal oxide. Some commercially available supported mixed metal oxides useful herein include cobalt oxide-molybdenum oxide, comprising 3.5% cobalt oxide and 14% molybdenum oxide, available from Strem Chemicals (Newburyport, Mass.).

In embodiments herein, the mixed metal oxides employed in the process of this invention are bound to or deposited on a solid support, which may simplify catalyst recovery. In addition, the support may increase catalyst strength and attrition resistance. Any suitable support may be used to make the supported mixed metal oxide catalysts of the present invention. Preferably, the supported material is a porous support material, for example, inorganic oxides. Other support materials may include zeolites, clays, organoclays, or any other organic or inorganic support material, and the like, or mixtures thereof. Suitable catalyst supports include, without limitation, silicas; aluminas; silica-aluminas; aluminosilicates, including zeolites, and other crystalline porous aluminosilicates; as well as titanias; zirconia; magnesium oxide; carbon; and cross-linked polymeric resins, such as functionalized cross-linked polystyrenes, e.g., chloromethyl-functionalized cross-linked polystyrenes; preferably silica or alumina. In preferred embodiments, the supported mixed metal oxide catalyst is supported on alumina, silica, calcium oxide, magnesium oxide, or a combination thereof.

The mixed metal oxides may be deposited onto the support by any method known to those skilled in the art, including, for example, impregnation, ion-exchange, spray coating, deposition-precipitation, and vapor deposition. Eggshell catalysts are also within the scope of the present invention. Eggshell catalysts (also referred to as “eggshell-type” catalysts) are supported catalysts where the active component or its precursor is provided principally as a thin outer layer on the surface of the support, as opposed to being dispersed evenly within the support. Alternatively, a component of the catalyst, such as the mixed metal oxides, may be chemically bound to the support via one or more covalent chemical bonds, for example, the catalyst may be immobilized by one or more covalent bonds with the oxygen atom of the mixed metal oxide. Further, the mixed metal oxides may be preloaded onto the solid support. Alternatively, the supported catalyst may be generated in situ.

The mixed metal oxides may be loaded onto the catalyst support in any amount, provided that during the process of this invention a product having a higher viscosity than the oligomer composition is produced. Generally, the catalyst compound is loaded onto the support in an amount based on the weight of the total metal content, relative to the total weight of the catalysts plus support. The catalyst compound may be loaded onto the support in an amount greater than about 0.01 wt % of the total metal content, based upon the weight of the catalysts plus support, and preferably greater than about 0.05 wt % of the total metal content. Generally, the catalyst compound is loaded onto the support in an amount that is less than about 20 wt % of the total metal content, and preferably less than about 10 wt % of the total metal content.

In some embodiments, the supported mixed metal oxide is calcined. In preferred embodiments, the supported mixed metal oxide catalyst is calcined at a temperature in the range of 200° C. to 1000° C., preferably in the range of 450° C. to 650° C., before use in the polymerization process.

In other embodiments, the supported mixed metal oxide catalyst comprises one or more promoter, wherein the promoter is an element selected from the group consisting of Na, S, Si, Mg, B, Ba, Zn, Sb, and W. In preferred embodiments, the supported mixed metal oxide catalyst comprises one or more elements selected from the group consisting of Na, Si, Mg, B, Zn, Sb, and W. In such embodiments, the promoter is admixed in small amounts (2% to 10%, by weight, preferably 3% to 8%, preferably 3% to 5%) with the supported mixed metal oxide, and the admixture is treated at elevated temperature (preferably 400° C. to 800° C., more preferably 450° C. to 700° C., more preferably 500° C. to 600° C.) under an inert atmosphere for a short period of time (from 30 to 60 minutes, preferably from 35 to 55 minutes).

### Optional Activators

The catalyst systems useful herein may further comprise an activator, preferably an alkyl tin compound. The alkyl tin compound may be any tetravalent tin compound useful as an activator, for example, tetraalkylin compounds. For example, tributyltin hydride may be useful herein. Tetraalkyltin compounds are represented by the formula SnT4, where T is a straight or branched chain alkyl of 1 to 10 carbon atoms. For example, tetramethyltin and tetrabutyltin are particularly useful herein.

### Vinyl Terminated Oligomer Composition

In preferred embodiments herein, the oligomer composition comprises vinyl terminated oligomers (also referred to as “macromonomers” or “macromers”). Oligomers having allyl chain ends (as defined below) are referred to as vinyl terminated oligomers. In embodiments herein, the oligomer composition comprises oligomers having at least 5% (at least 10%, at least 15%, at least 20%, at least 30%, at least 40%, at least 50%, at least 60%, at least 70%; at least 80%, at least 90%, or at least 95%) allyl chain ends (relative to total unsaturation).

In some embodiments of the invention, the oligomer composition comprises oligomers having a Mn in the range of from about 300 g/mol to about 30,000 g/mol.

In some embodiments of the invention, the oligomer composition is a recycle stream from another process, such as a polyalphaolefin process, and may comprise different oligomers.

In some embodiments of the invention, the oligomer composition comprises a vinyl terminated macromonomer. In some embodiments, a “vinyl terminated macromonomer,” includes, but is not limited to, one or more of:

(i) a vinyl terminated polymer having an Mn of at least 200 g/mol (measured by ¹H NMR) comprising of one or more C₄ to C₄₀ higher olefin derived units, where the higher olefin polymer comprises substantially no propylene derived units; and wherein the higher olefin polymer has at least 5% allyl chain ends;
(ii) a copolymer having an Mn of 200 g/mol or more (measured by ¹H NMR) comprising (a) from about 20 mol % to about 99.9 mol % of at least one C₅ to C₄₀ higher olefin, and (b) from about 0.1 mol % to about 80 mol % of propylene, wherein the higher olefin copolymer has at least 40% allyl chain ends;
(iii) a copolymer having an Mn of 200 g/mol or more (measured by ¹H NMR), and comprises (a) from about 80 mol % to about 99.9 mol % of at least one C₄ olefin, and (b) from about 0.1 mol % to about 20 mol % of propylene; wherein the vinyl terminated macromonomer has at least 40% allyl chain ends relative to total unsaturation;
(iv) a co-oligomer having an Mn of 200 g/mol to 30,000 g/mol (measured by ¹H NMR) comprising 10 mol % to 90 mol % propylene and 10 mol % to 90 mol % of ethylene, wherein the oligomer has at least X % allyl chain ends (relative to total unsaturations), where: 1) X=(−0.94*(mol % ethylene incorporated)+100), when 10 mol % to 60 mol % ethylene is present in the co-oligomer, 2) X=45, when greater than 60 mol % and less than 70 mol % ethylene is present in the co-oligomer, and 3) X=(1.83*(mol % ethylene incorporated)−83), when 70 mol % to 90 mol % ethylene is present in the co-oligomer;
(v) a propylene oligomer, comprising more than 90 mol % propylene and less than 10 mol % ethylene wherein the oligomer has: at least 93% allyl chain ends, a number average molecular weight (Mn) of about 500 g/mol to about 20,000 g/mol, an isobutyl chain end to allylic vinyl group ratio of 0.8:1 to 1.35:1.0, and less than 100 ppm aluminum;
(vi) a propylene oligomer, comprising: at least 50 mol % propylene and from 10 mol % to 50 mol % ethylene, wherein the oligomer has: at least 90% allyl chain ends, an Mn of about 150 g/mol to about 10,000 g/mol, and an isobutyl chain end to allylic vinyl group ratio of 0.8:1 to 1.2:1.0, wherein monomers having four or more carbon atoms are present at from 0 mol % to 3 mol %;
(vii) a propylene oligomer, comprising: at least 50 mol % propylene, from 0.1 mol % to 45 mol % ethylene, and from 0.1 mol % to 5 mol % C₄ to C₁₂ olefin, wherein the oligomer has: at least 90% allyl chain ends, an Mn of about 150 g/mol to about 10,000 g/mol, and an isobutyl chain end to allylic vinyl group ratio of 0.8:1 to 1.35:1.0;
(viii) a propylene oligomer, comprising: at least 50 mol % propylene, from 0.1 mol % to 45 mol % ethylene, and from 0.1 mol % to 5 mol % diene (preferably such as C₄ to C₁₂ alpha-omega dienes (such as butadiene, hexadiene, octadiene), norbornene, ethylidene norbornene, vinylnorbornene, norbornadiene, and dicyclopentadiene), wherein the oligomer has: at least 90% allyl chain ends, an Mn of about 150 g/mol to about 10,000 g/mol, and an isobutyl chain end to allylic vinyl group ratio of 0.7:1 to 1.35:1.0;
(ix) a homo-oligomer, comprising propylene, wherein the oligomer has: at least 93% allyl chain ends, an Mn of about 500 g/mol to about 20,000 g/mol, an isobutyl chain end to allylic vinyl group ratio of 0.8:1 to 1.2:1.0, and less than 1400 ppm aluminum;
(x) a co-oligomer having an Mn (¹H NMR) of 7,500 to 60,000 g/mol comprising one or more alpha olefin derived units comprising ethylene and/or propylene, and having 50% or greater allyl chain ends, relative to total number of unsaturated chain ends and a g'vis of 0.90 or less (g'vis is determined using GPC-DRI, as described below);
(xi) a branched polyolefin having an Mn (GPC) greater than 60,000 g/mol comprising one or more alpha olefins comprising ethylene and/or propylene, and having: (i) 50% or greater allyl chain ends, relative to total unsaturated chain ends; (ii) a g'vis of 0.90 or less; and optionally, (iii) a bromine number which, upon complete hydrogenation, decreases by at least 50% (bromine number is determined by ASTM D 1159); and
(xii) a branched polyolefin having an Mn (¹H NMR) of less than 7,500 g/mol comprising one or more alpha olefin derived units comprising ethylene and/or propylene, and having: a ratio of percentage of saturated chain ends to percentage of allyl chain ends of 1.2 to 2.0; and 50% or greater allyl chain ends, relative to total unsaturated chain ends.

Any of the vinyl terminated macromonomers described herein may be homopolymers, copolymers, terpolymers, and so on.

In any embodiment of the invention, the vinyl terminated macromonomer may have a Tg of less than 0° C. or less (as determined by differential scanning calorimetry as described below), preferably −10° C. or less, more preferably −20° C. or less, more preferably −30° C. or less, more preferably −50° C. or less.

In any embodiment of the invention, the vinyl terminated macromonomers described herein may have a melting point (DSC first melt, as described below) of from 60° C. to 130° C., alternately 50° C. to 100° C. In another embodiment, the vinyl terminated macromonomers described herein have no detectable melting point by DSC following storage at ambient temperature (23° C.) for at least 48 hours.

In any embodiment of the invention, the vinyl terminated macromonomer may be a liquid at 25° C. In any embodiments of the invention, the vinyl terminated macromonomer may have an isobutyl chain end to allylic vinyl group ratio of 0.7:1 to 1.35:1.0.

In any embodiment of the invention, the vinyl terminated macromonomer may have less than 3 wt % of functional groups selected from hydroxide, aryls and substituted aryls, halogens, alkoxys, carboxylates, esters, acrylates, oxygen, nitrogen, and carboxyl, preferably less than 2 wt %, more preferably less than 1 wt %, more preferably less than 0.5 wt %, more preferably less than 0.1 wt %, more preferably 0 wt %, based upon the weight of the oligomer.

Vinyl terminated macromonomers generally have a saturated chain end (or terminus) and/or an unsaturated chain end or terminus. The unsaturated chain end of the vinyl terminated macromonomer comprises an “allyl chain end” or a “3-alkyl” chain end. An allyl chain end is represented by CH₂CH—CH₂₋, as shown in the formula:

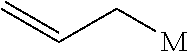

where M represents the polymer chain. “Allylic vinyl group,” “allyl chain end,” “vinyl chain end,” “vinyl termination,” “allylic vinyl group,” and “vinyl terminated” are used interchangeably in the following description. The number of allyl chain ends, vinylidene chain ends, vinylene chain ends, and other unsaturated chain ends is determined using ¹H NMR at 120° C. using deuterated tetrachloroethane as the solvent on an at least 250 MHz NMR spectrometer, and in selected cases, confirmed by ¹³C NMR. Resconi has reported proton and carbon assignments (neat perdeuterated tetrachloroethane used for proton spectra, while a 50:50 mixture of normal and perdeuterated tetrachloroethane was used for carbon spectra; all spectra were recorded at 100° C. on a BRUKER spectrometer operating at 500 MHz for proton and 125 MHz for carbon) for vinyl terminated oligomers in J. American Chemical Soc., 114, 1992, pp. 1025-1032 that are useful herein. Allyl chain ends are reported as a molar percentage of the total number of moles of unsaturated groups (that is, the sum of allyl chain ends, vinylidene chain ends, vinylene chain ends, and the like).

A 3-alkyl chain end (where the alkyl is a C₁ to C₃₈ alkyl), also referred to as a “3-alkyl vinyl end group” or a “3-alkyl vinyl termination,” is represented by the formula:

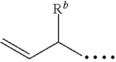

3-alkyl vinyl end group
   where “” represents the polyolefin chain and R^{b} is a C₁ to C₃₈ alkyl group, or a C₁ to C₂₀ alkyl group, such as methyl, ethyl, propyl, butyl, pentyl, hexyl, heptyl, octyl, nonyl, decyl, undecyl, dodecyl, and the like. The amount of 3-alkyl chain ends is determined using ¹³C NMR as set out below.

¹³C NMR data is collected at 120° C. at a frequency of at least 100 MHz, using a BRUKER 400 MHz NMR spectrometer. A 90 degree pulse, an acquisition time adjusted to give a digital resolution between 0.1 and 0.12 Hz, at least a 10 second pulse acquisition delay time with continuous broadband proton decoupling using swept square wave modulation without gating is employed during the entire acquisition period. The spectra is acquired with time averaging to provide a signal to noise level adequate to measure the signals of interest. Samples are dissolved in tetrachloroethane-d₂ at concentrations between 10 wt % to 15 wt % prior to being inserted into the spectrometer magnet. Prior to data analysis spectra are referenced by setting the chemical shift of the TCE solvent signal to 74.39 ppm. Chain ends for quantization were identified using the signals shown in the table below. N-butyl and n-propyl were not reported due to their low abundance (less than 5%) relative to the chain ends shown in the table below.

| Chain End | ¹³C NMR Chemical Shift |
|---|---|
| P~i-Bu | 23-5 to 25.5 and 25.8 to 26.3 ppm |
| E~i-Bu | 39.5 to 40.2 ppm |
| P~Vinyl | 41.5 to 43 ppm |
| E~Vinyl | 33.9 to 34.4 ppm |

The “allyl chain end to vinylidene chain end ratio” is defined to be the ratio of the percentage of allyl chain ends to the percentage of vinylidene chain ends. The “allyl chain end to vinylene chain end ratio” is defined to be the ratio of the percentage of allyl chain ends to the percentage of vinylene chain ends. Vinyl terminated macromonomers typically also have a saturated chain end. In polymerizations where propylene is present, the polymer chain may initiate growth in a propylene monomer, thereby generating an isobutyl chain end. An “isobutyl chain end” is defined to be an end or terminus of a polymer, represented as shown in the formula below:

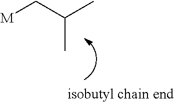

where M represents the polymer chain. Isobutyl chain ends are determined according to the procedure set out in WO 2009/155471. The “isobutyl chain end to allylic vinyl group ratio” is defined to be the ratio of the percentage of isobutyl chain ends to the percentage of allyl chain ends.

In polymerizations comprising C₄ or greater monomers (or “higher olefin” monomers), the saturated chain end may be a C₄ or greater (or “higher olefin”) chain end, as shown in the formula below:

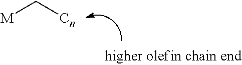

where M represents the polymer chain and n is an integer selected from 4 to 40. This is especially true when there is substantially no ethylene or propylene in the polymerization. In an ethylene/(C₄ or greater monomer) copolymerization, the polymer chain may initiate growth in an ethylene monomer, thereby generating a saturated chain end which is an ethyl chain end. Mn (¹H NMR) is determined according to the following NMR method. ¹H NMR data is collected at either room temperature or 120° C. (for purposes of the claims, 120° C. shall be used) in a 5 mm probe using a Varian spectrometer with a ¹H frequency of 250 MHz, 400 MHz, or 500 MHz (for the purpose of the claims, a proton frequency of 400 MHz is used). Data are recorded using a maximum pulse width of 45° C., 8 seconds between pulses, and signal averaging 120 transients. Spectral signals are integrated and the number of unsaturation types per 1000 carbons is calculated by multiplying the different groups by 1000 and dividing the result by the total number of carbons. Mn is calculated by dividing the total number of unsaturated species into 14,000, and has units of g/mol. The chemical shift regions for the olefin types are defined to be between the following spectral regions.

| Unsaturation Type | Region (ppm) | Number of hydrogens per structure |
|---|---|---|
| Vinyl | 4.95-5.10 | 2 |
| Vinylidene (VYD) | 4.70-4.84 | 2 |
| Vinylene | 5.31-5.55 | 2 |
| Trisubstituted | 5.11-5.30 | 1 |

Mn, Mw, Mz, carbon number, and g'vis are measured by a GPC-DRI (Gel Permeation Chromatograph-Differential Refractive Index) method using a High Temperature Size Exclusion Chromatograph (SEC, either from Waters Corporation or Polymer Laboratories), equipped with a DRI. Experimental details, are described in: T. Sun, P. Brant, R. R. Chance, and W. W. Graessley, Macromolecules, 2001, Volume 34, Number 19, pp. 6812-6820 and references therein. Three Polymer Laboratories PLgel 10 mm Mixed-B columns are used. The nominal flow rate is 0.5 cm³/min, and the nominal injection volume is 300 μL. The various transfer lines, columns and differential refractometer (the DRI detector) are contained in an oven maintained at 135° C. Solvent for the SEC experiment is prepared by dissolving 6 grams of butylated hydroxy toluene as an antioxidant in 4 liters of Aldrich reagent grade 1,2,4-trichlorobenzene (TCB). The TCB mixture is then filtered through a 0.7 μm glass pre-filter and subsequently through a 0.1 μm Teflon filter. The TCB is then degassed with an online degasser before entering the SEC. Polymer solutions are prepared by placing dry polymer in a glass container, adding the desired amount of TCB, then heating the mixture at 160° C. with continuous agitation for about 2 hours. All quantities are measured gravimetrically. The TCB densities used to express the polymer concentration in mass/volume units are 1.463 g/mL at room temperature and 1.324 g/mL at 135° C. The injection concentration is from 1.0 to 2.0 mg/mL, with lower concentrations being used for higher molecular weight samples. Prior to running each sample the DRI detector and the injector are purged. Flow rate in the apparatus is then increased to 0.5 mL/minute, and the DRI is allowed to stabilize for 8 to 9 hours before injecting the first sample. The concentration, c, at each point in the chromatogram is calculated from the baseline-subtracted DRI signal, I_{DRI}, using the following equation:

c=K_{DRI}I_{DRI}/(dn/dc)

where K_{DRI} is a constant determined by calibrating the DRI, and (dn/dc) is the refractive index increment for the system. The refractive index, n=1.500 for TCB at 135° C. and λ=690 nm. For purposes of this invention and the claims thereto (dn/dc)=0.104 for propylene polymers and 0.1 otherwise. Units of parameters used throughout this description of the SEC method are: concentration is expressed in g/cm³, molecular weight is expressed in g/mol, and intrinsic viscosity is expressed in dL/g.

The LS detector is a Wyatt Technology High Temperature mini-DAWN. The molecular weight, M, at each point in the chromatogram is determined by analyzing the LS output using the Zimm model for static light scattering (M. B. Huglin, LIGHT SCATTERING FROM POLYMER SOLUTIONS, Academic Press, 1971):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the DRI analysis, A₂ is the second virial coefficient [for purposes of this invention, A₂=0.0006 for propylene polymers, 0.0015 for butene polymers and 0.001 otherwise], (dn/dc)=0.104 for propylene polymers, 0.098 for butene polymers and 0.1 otherwise, P(θ) is the form factor for a monodisperse random coil, and K_{O} is the optical constant for the system:

$${K}_{o} = \frac{4 {π}^{2} {{n}^{2} ( dn \text{/} dc )}^{2}}{{λ}^{4} {N}_{A}}$$

where N_{A} is Avogadro's number, and (dn/dc) is the refractive index increment for the system. The refractive index, n=1.500 for TCB at 145° C. and λ=690 nm.

A high temperature Viscotek Corporation viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηₛ=c[η]+0.3(c[η])²

where c is concentration and was determined from the DRI output.

The branching index (g′ᵥᵢₛ) is calculated using the output of the SEC-DRI-LS-VIS method as follows. The average intrinsic viscosity, [η]_{avg}, of the sample is calculated by:

$${[ η ]}_{avg} = \frac{Σ {{c}_{i} [ η ]}_{i}}{Σ {c}_{i}}$$

where the summations are over the chromatographic slices, i, between the integration limits. The branching index g′vis is defined as:

$${g}^{′} vis = \frac{{[ η ]}_{avg}}{{kM}_{v}^{α}}$$

where, for purpose of this invention and claims thereto, α=0.695 and k=0.000579 for linear ethylene polymers, α=0.705 k=0.000262 for linear propylene polymers, and α=0.695 and k=0.000181 for linear butene polymers. M_{V} is the viscosity-average molecular weight based on molecular weights determined by LS analysis. See Macromolecules, 2001, 34, pp. 6812-6820 and Macromolecules, 2005, 38, pp. 7181-7183, for guidance on selecting a linear standard having similar molecular weight and comonomer content, and determining k coefficients and α exponents.

Tm, Hf, and Tg are measured using Differential Scanning calorimetry (DSC) using commercially available equipment such as a TA Instruments Model Q100. Typically, 6 to 10 mg of the sample, that has been stored at room temperature for at least 48 hours, is sealed in an aluminum pan and loaded into the instrument at room temperature. The sample is equilibrated at 25° C., then it is cooled at a cooling rate of 10° C./min to −80° C. The sample is held at −80° C. for 5 min and then heated at a heating rate of 10° C./min to 25° C. The glass transition temperature is measured from the heating cycle. Alternatively, the sample is equilibrated at 25° C. for 5 minutes, then heated at a heating rate of 10° C./min to 200° C., followed by an equilibration at 200° C. for 5 minutes, and cooled at 10° C./min to −80° C. The endothermic melting transition, if present, is analyzed for onset of transition and peak temperature. The melting temperatures reported are the peak melting temperatures from the first heat unless otherwise specified. For samples displaying multiple peaks, the melting point (or melting temperature) is defined to be the peak melting temperature associated with the largest endothermic calorimetric response in that range of temperatures from the DSC melting trace. Areas under the DSC curve are used to determine the heat of transition (heat of fusion, Hf, upon melting or heat of crystallization, Hc, upon crystallization, if the Hf value from the melting is different from the Hc value obtained for the heat of crystallization, then the value from the melting (Tm) shall be used), which can be used to calculate the degree of crystallinity (also called the percent crystallinity). The percent crystallinity (X %) is calculated using the formula: [area under the curve (in J/g)/H° (in J/g)]*100, where H° is the heat of fusion for the homopolymer of the major monomer component. These values for H° are to be obtained from the Polymer Handbook, Fourth Edition, published by John Wiley and Sons, New York 1999, except that a value of 290 J/g is used as the equilibrium heat of fusion (H°) for 100% crystalline polyethylene, a value of 140 J/g is used as the equilibrium heat of fusion (H°) for 100% crystalline polybutene, and a value of 207 J/g (H°) is used as the heat of fusion for a 100% crystalline polypropylene.

In some embodiments of the invention, the vinyl terminated macromonomer has an Mn of at least 200 g/mol, (e.g., 200 g/mol to 100,000 g/mol, e.g., 200 g/mol to 75,000 g/mol, e.g., 200 g/mol to 60,000 g/mol, e.g., 300 g/mol to 60,000 g/mol, or e.g., 750 g/mol to 30,000 g/mol) (measured by ¹H NMR) and comprise one or more (e.g., two or more, three or more, four or more, and the like) C₄ to C₄₀ (e.g., C₄ to C₃₀, C₄ to C₂₀, or C₄ to C₁₂, e.g., butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof) olefin derived units, where the vinyl terminated macromonomer comprises substantially no propylene derived units (e.g., less than 0.1 wt % propylene, e.g., 0 wt %); and wherein the vinyl terminated macromonomer has at least 5% (at least 10%, at least 15%, at least 20%, at least 30%, at least 40%, at least 50%, at least 60%, at least 70%; at least 80%, at least 90%, or at least 95%) allyl chain ends (relative to total unsaturation); and optionally, an allyl chain end to vinylidene chain end ratio of 1:1 or greater (e.g., greater than 2:1, greater than 2.5:1, greater than 3:1, greater than 5:1, or greater than 10:1); and even further optionally, e.g., substantially no isobutyl chain ends (e.g., less than 0.1 wt % isobutyl chain ends). In some embodiments, the vinyl terminated macromonomers may also comprise ethylene derived units, e.g., at least 5 mol % ethylene (e.g., at least 15 mol % ethylene, e.g., at least 25 mol % ethylene, e.g., at least 35 mol % ethylene, e.g., at least 45 mol % ethylene, e.g., at least 60 mol % ethylene, e.g., at least 75 mol % ethylene, or e.g., at least 90 mol % ethylene). Such vinyl terminated macromonomers and methods to make them are further described in U.S. Ser. No. 13/072,288, filed on Mar. 25, 2011 (published as US ______), which is hereby incorporated by reference.

In some embodiments of the invention, the vinyl terminated macromonomers may have an Mn (measured by ¹H NMR) of greater than 200 g/mol (e.g., 300 g/mol to 60,000 g/mol, 400 g/mol to 50,000 g/mol, 500 g/mol to 35,000 g/mol, 300 g/mol to 15,000 g/mol, 400 g/mol to 12,000 g/mol, or 750 g/mol to 10,000 g/mol), and comprise:

(a) from about 20 mol % to 99.9 mol % (e.g., from about 25 mol % to about 90 mol %, from about 30 mol % to about 85 mol %, from about 35 mol % to about 80 mol %, from about 40 mol % to about 75 mol %, or from about 50 mol % to about 95 mol %) of at least one C₅ to C₄₀ (e.g., C₆ to C₂₀) higher olefin; and
(b) from about 0.1 mol % to about 80 mol % (e.g., from about 5 mol % to about 70 mol %, from about 10 mol % to about 65 mol %, from about 15 mol % to about 55 mol %, from about 25 mol % to about 50 mol %, or from about 30 mol % to about 80 mol %) of propylene;
wherein the vinyl terminated macromonomer has at least 40% allyl chain ends (e.g., at least 50% allyl chain ends, at least 60% allyl chain ends, at least 70% allyl chain ends, at least 80% allyl chain ends, at least 90% allyl chain ends, or at least 95% allyl chain ends) relative to total unsaturation; and, optionally, an isobutyl chain end to allyl chain end ratio of less than 0.70:1, less than 0.65:1, less than 0.60:1, less than 0.50:1, or less than 0.25:1; and further optionally, an allyl chain end to vinylidene chain end ratio of greater than 2:1 (e.g., greater than 2.5:1, greater than 3:1, greater than 5:1, or greater than 10:1); and even further optionally, an allyl chain end to vinylene ratio is greater than 1:1 (e.g., greater than 2:1 or greater than 5:1). Such macromonomers and methods to make them are further described in U.S. Ser. No. 13/072,249, filed on Mar. 25, 2011 (published as US ______, hereby incorporated by reference.

In another embodiment of the invention, the vinyl terminated macromonomer has an Mn of 300 g/mol or more (measured by ¹H NMR, e.g., 300 g/mol to 60,000 g/mol, 400 g/mol to 50,000 g/mol, 500 g/mol to 35,000 g/mol, 300 g/mol to 15,000 g/mol, 400 g/mol to 12,000 g/mol, or 750 g/mol to 10,000 g/mol), and comprises:

(a) from about 80 mol % to about 99.9 mol % of at least one C₄ olefin, e.g., about 85 mol % to about 99.9 mol %, e.g., about 90 mol % to about 99.9 mol %;
(b) from about 0.1 mol % to about 20 mol % of propylene, e.g., about 0.1 mol % to about 15 mol %, e.g., about 0.1 mol % to about 10 mol %; and
wherein the vinyl terminated macromonomer has at least 40% allyl chain ends (e.g., at least 50% allyl chain ends, at least 60% allyl chain ends, at least 70% allyl chain ends, at least 80% allyl chain ends, at least 90% allyl chain ends, or at least 95% allyl chain ends) relative to total unsaturation; and in some embodiments, an isobutyl chain end to allyl chain end ratio of less than 0.70:1, less than 0.65:1, less than 0.60:1, less than 0.50:1, or less than 0.25:1, and in further embodiments, an allyl chain end to vinylidene group ratio of more than 2:1, more than 2.5:1, more than 3:1, more than 5:1, or more than 10:1. Such macromonomers and methods to make them are also further described in U.S. Ser. No. 13/072,249 filed on Mar. 25, 2011 (published as US ______, hereby incorporated by reference.

In other embodiments of the invention, the vinyl terminated macromonomer is a propylene co-oligomer having an Mn of 300 g/mol to 30,000 g/mol as measured by ¹H NMR (e.g., 400 g/mol to 20,000 g/mol, e.g., 500 g/mol to 15,000 g/mol, e.g., 600 g/mol to 12,000 g/mol, e.g., 800 g/mol to 10,000 g/mol, e.g., 900 g/mol to 8,000 g/mol, e.g., 900 g/mol to 7,000 g/mol), comprising 10 mol % to 90 mol % propylene (e.g., 15 mol % to 85 mol %, e.g., 20 mol % to 80 mol %, e.g., 30 mol % to 75 mol %, e.g., 50 mol % to 90 mol %) and 10 mol % to 90 mol % (e.g., 85 mol % to 15 mol %, e.g., 20 mol % to 80 mol %, e.g., 25 mol % to 70 mol %, e.g., 10 mol % to 50 mol %) of one or more alpha-olefin comonomers (e.g., ethylene, butene, hexene, or octene, e.g., ethylene), wherein the oligomer has at least X % allyl chain ends (relative to total unsaturations), where: 1) X=(−0.94*(mol % ethylene incorporated)+100{alternately 1.20 (−0.94 (mol % ethylene incorporated)+100), alternately 1.50(−0.94 (mol % ethylene incorporated)+100)}), when 10 mol % to 60 mol % ethylene is present in the co-oligomer; 2) X=45 (alternately 50, alternately 60), when greater than 60 mol % and less than 70 mol % ethylene is present in the co-oligomer; and 3) X=(1.83*(mol % ethylene incorporated)−83, {alternately 1.20 [1.83*(mol % ethylene incorporated)−83], alternately 1.50 [1.83*(mol % ethylene incorporated)−83]}), when 70 mol % to 90 mol % ethylene is present in the co-oligomer. Such macromonomers and methods to make them are further described in U.S. Ser. No. 12/143,663, filed on Jun. 20, 2008, published as US 2009/0318644, hereby incorporated by reference.

In other embodiments of the invention, the vinyl terminated macromonomer is a propylene oligomer, comprising more than 90 mol % propylene (e.g., 95 mol % to 99 mol %, e.g., 98 mol % to 9 mol %) and less than 10 mol % ethylene (e.g., 1 mol % to 4 mol %, e.g., 1 mol % to 2 mol %), wherein the oligomer has: at least 93% allyl chain ends (e.g., at least 95%, e.g., at least 97%, e.g., at least 98%); a number average molecular weight (Mn) of about 400 g/mol to about 30,000 g/mol, as measured by ¹H NMR (e.g., 500 g/mol to 20,000 g/mol, e.g., 600 g/mol to 15,000 g/mol, e.g., 700 g/mol to 10,000 g/mol, e.g., 800 g/mol to 9,000 g/mol, e.g., 900 g/mol to 8,000 g/mol, e.g., 1,000 g/mol to 6,000 g/mol); an isobutyl chain end to allylic vinyl group ratio of 0.8:1 to 1.35:1.0, and less than 1400 ppm aluminum, (e.g., less than 1200 ppm, e.g., less than 1000 ppm, e.g., less than 500 ppm, e.g., less than 100 ppm). Such macromonomers and methods to make them are further described in U.S. Ser. No. 12/143,663, filed on Jun. 20, 2008, published as US 2009/0318644, hereby incorporated by reference.

In other embodiments of the invention, the vinyl terminated macromonomer is a propylene oligomer, comprising: at least 50 mol % (e.g., 60 mol % to 90 mol %, e.g., 70 mol % to 90 mol %) propylene and from 10 mol % to 50 mol % (e.g., 10 mol % to 40 mol %, e.g., 10 mol % to 30 mol %) ethylene, wherein the oligomer has: at least 90% allyl chain ends (e.g., at least 91%, e.g., at least 93%, e.g., at least 95%, e.g., at least 98%); an Mn of about 150 g/mol to about 20,000 g/mol, as measured by ¹H NMR (e.g., 200 g/mol to 15,000 g/mol, e.g., 250 g/mol to 15,000 g/mol, e.g., 300 g/mol to 10,000 g/mol, e.g., 400 g/mol to 9,500 g/mol, e.g., 500 g/mol to 9,000 g/mol, e.g., 750 g/mol to 9,000 g/mol); and an isobutyl chain end to allylic vinyl group ratio of 0.8:1 to 1.3:1.0, wherein monomers having four or more carbon atoms are present at from 0 mol % to 3 mol % (e.g., at less than 1 mol %, e.g., less than 0.5 mol %, e.g., at 0 mol %). Such macromonomers and methods to make them are further described in U.S. Ser. No. 12/143,663, filed on Jun. 20, 2008, published as US 2009/0318644, hereby incorporated by reference.

In other embodiments of the invention, the vinyl terminated macromonomer is a propylene oligomer, comprising: at least 50 mol % (e.g., at least 60 mol %, e.g., 70 mol % to 99.5 mol %, e.g., 80 mol % to 99 mol %, e.g., 90 mol % to 98.5 mol %) propylene, from 0.1 mol % to 45 mol % (e.g., at least 35 mol %, e.g., 0.5 mol % to 30 mol %, e.g., 1 mol % to 20 mol %, e.g., 1.5 mol % to 10 mol %) ethylene, and from 0.1 mol % to 5 mol % (e.g., 0.5 mol % to 3 mol %, e.g., 0.5 mol % to 1 mol %) C₄ to C₁₂ olefin (such as butene, hexene, or octene, e.g., butene), wherein the oligomer has: at least 90% allyl chain ends (e.g., at least 91%, e.g., at least 93%, e.g., at least 95%, e.g., at least 98%); a number average molecular weight (Mn) of about 150 g/mol to about 15,000 g/mol, as measured by ¹H NMR (e.g., 200 g/mol to 12,000 g/mol, e.g., 250 g/mol to 10,000 g/mol, e.g., 300 g/mol to 10,000 g/mol, e.g., 400 g/mol to 9500 g/mol, e.g., 500 g/mol to 9,000 g/mol, e.g., 750 g/mol to 9,000 g/mol); and an isobutyl chain end to allylic vinyl group ratio of 0.8:1 to 1.35:1.0. Such macromonomers and methods to make them are further described in U.S. Ser. No. 12/143,663, filed on Jun. 20, 2008, published as US 2009/0318644, hereby incorporated by reference.

In other embodiments of the invention, the vinyl terminated macromonomer is a propylene oligomer, comprising: at least 50 mol % (e.g., at least 60 mol %, e.g., 70 mol % to 99.5 mol %, e.g., 80 mol % to 99 mol %, e.g., 90 mol % to 98.5 mol %) propylene, from 0.1 mol % to 45 mol % (e.g., at least 35 mol %, e.g., 0.5 mol % to 30 mol %, e.g., 1 mol % to 20 mol %, e.g., 1.5 mol % to 10 mol %) ethylene, and from 0.1 mol % to 5 mol % (e.g., 0.5 mol % to 3 mol %, e.g., 0.5 mol % to 1 mol %) diene (such as C₄ to C₁₂ alpha-omega dienes (such as butadiene, hexadiene, octadiene), norbornene, ethylidene norbornene, vinylnorbornene, norbornadiene, and dicyclopentadiene), wherein the oligomer has at least 90% allyl chain ends (e.g., at least 91%, e.g., at least 93%, e.g., at least 95%, e.g., at least 98%); a number average molecular weight (Mn) of about 150 g/mol to about 20,000 g/mol, as measured by ¹H NMR (e.g., 200 g/mol to 15,000 g/mol, e.g., 250 g/mol to 12,000 g/mol, e.g., 300 g/mol to 10,000 g/mol, e.g., 400 g/mol to 9,500 g/mol, e.g., 500 g/mol to 9,000 g/mol, e.g., 750 g/mol to 9,000 g/mol); and an isobutyl chain end to allylic vinyl group ratio of 0.7:1 to 1.35:1.0. Such macromonomers and methods to make them are further described in U.S. Ser. No. 12/143,663, filed on Jun. 20, 2008, published as US 2009/0318644, hereby incorporated by reference.

In other embodiments of the invention, the vinyl terminated macromonomer is a propylene homo-oligomer, comprising propylene and less than 0.5 wt % comonomer, e.g., 0 wt % comonomer, wherein the oligomer has:

i) at least 93% allyl chain ends (e.g., at least 95%, e.g., at least 96%, e.g., at least 97%, e.g., at least 98%, e.g., at least 99%);
ii) a number average molecular weight (Mn) of about 500 g/mol to about 20,000 g/mol, as measured by ¹H NMR (e.g., 500 g/mol to 15,000 g/mol, e.g., 700 g/mol to 10,000 g/mol, e.g., 800 g/mol to 8,000 g/mol, e.g., 900 g/mol to 7,000 g/mol, e.g., 1,000 g/mol to 6,000 g/mol, e.g., 1,000 g/mol to 5,000 g/mol);
iii) an isobutyl chain end to allylic vinyl group ratio of 0.8:1 to 1.3:1.0; and
iv) less than 1400 ppm aluminum, (e.g., less than 1200 ppm, e.g., less than 1000 ppm, e.g., less than 500 ppm, e.g., less than 100 ppm). Such macromonomers and methods to make them are also further described in U.S. Ser. No. 12/143,663, filed on Jun. 20, 2008, published as US 2009/0318644, hereby incorporated by reference.

In yet other embodiments of the invention, the vinyl terminated macromonomer is a branched polyolefin having an Mn (measured by ¹H NMR) of 7,500 to 60,000 g/mol, comprising one or more alpha olefins (preferably propylene and/or ethylene, preferably propylene) and, optionally, a C₄ to C₄₀ alpha olefin (preferably a C₄ to C₂₀ alpha olefin, preferably a C₄ to C₁₂ alpha olefin, preferably butene, pentene, hexene, heptene, octene, nonene, decene, cyclopentene, cycloheptene, cyclooctene, cyclooctadiene, and isomers thereof), and having:

(i) 50% or greater allyl chain ends, relative to total unsaturated chain ends (preferably 60% or more, preferably 70% or more, preferably 75% or more, preferably 80% or more, preferably 90% or more, preferably 95% or more);
(ii) a g′vis of 0.90 or less (preferably 0.85 or less, preferably 0.80 or less); and/or a ratio of percentage of saturated chain ends (preferably isobutyl chain ends) to percentage of allyl chain ends of 1.2 to 2.0 (preferably 1.6 to 1.8), wherein the percentage of saturated chain ends is determined using ¹³C NMR as described in WO 2009/155471 at paragraph [0095] and [0096] except that the spectra are referenced to the chemical shift of the solvent, tetrachloroethane-d₂, and/or a ratio of Mn(GPC)/Mn(¹H NMR) of 0.95 or less (preferably 0.90 or less, preferably 0.85 or less, preferably 0.80 or less);
(iii) optionally, a peak melting point (Tm) of greater than 60° C. (preferably greater than 100° C., preferably from 60° C. to 180° C., preferably from 80 to 175° C.);
(iv) optionally, a heat of fusion (Hf) of greater than 7 J/g (preferably greater than 15 J/g, greater than 30 J/g, greater than 50 J/g, greater than 60 J/g, or greater than 80 J/g);
(v) optionally, an allyl chain end to internal vinylidene ratio of greater than 5:1 (preferably greater than 10:1);
(vi) optionally, an allyl chain end to vinylidene chain end ratio of greater than 10:1 (preferably greater than 15:1); and
(vii) optionally, an allyl chain end to vinylene chain end ratio of greater than 1:1 (preferably greater than 2:1, greater than 5:1, or greater than 10:1). Such macromonomers and methods to make them are further described in U.S. Ser. No. 13/411,929, filed on Mar. 5, 2012 (published as US ______), which is incorporated in its entirety herein.

In other embodiments of the invention, the vinyl terminated macromonomer is a branched polyolefin having an Mn (measured by GPC) of greater than 60,000 g/mol, comprising one or more alpha olefins (preferably propylene and/or ethylene, preferably propylene) and optionally, a C₄ to C₄₀ alpha olefin (preferably a C₄ to C₂₀ alpha olefin, preferably a C₄ to C₁₂ alpha olefin, preferably butene, pentene, hexene, heptene, octene, nonene, decene, cyclopentene, cycloheptene, cyclooctene, cyclooctadiene, and isomers thereof) and having:

(i) 50% or greater allyl chain ends, relative to total unsaturated chain ends (preferably 60% or more, preferably 70% or more, preferably 75% or more, preferably 80% or more, preferably 90% or more, preferably 95% or more);
(ii) a g′vis of 0.90 or less (preferably 0.85 or less, preferably 0.80 or less);
(iii) optionally, a bromine number which, upon complete hydrogenation, decreases by at least 50% (preferably at least 75%);
(iv) optionally, a Tm of greater than 60° C. (preferably greater than 100° C., preferably from 60° C. to 180° C., preferably from 80° C. to 175° C.); and
(v) optionally, an Hf of greater than 7 J/g (preferably greater than 15 J/g, greater than 30 J/g, greater than 50 J/g, greater than 60 J/g, or greater than 80 J/g). Such macromonomers and methods to make them are further described in U.S. Ser. No. 13/411,929, filed on Mar. 5, 2012 (published as US ______), which is incorporated in its entirety herein.

In yet other embodiments of the invention, the vinyl terminated macromonomer is a branched polyolefin having an Mn (measured by ¹H NMR) of less than 7,500 g/mol (preferably from 100 to 7,500 g/mol), comprising one or more alpha olefins (preferably propylene and/or ethylene, preferably propylene) and, optionally, a C₄ to C₄₀ alpha olefin (preferably a C₄ to C₂₀ alpha olefin, preferably a C₄ to C₁₂ alpha olefin, preferably butene, pentene, hexene, heptene, octene, nonene, decene, cyclopentene, cycloheptene, cyclooctene, cyclooctadiene, and isomers thereof) and having:

(i) 50% or greater allyl chain ends, relative to total number of unsaturated chain ends (preferably 60% or more, preferably 70% or more, preferably 75% or more, preferably 80% or more, preferably 90% or more, preferably 95% or more);
(ii) a ratio of percentage of saturated chain ends (preferably isobutyl chain ends) to percentage of allyl chain ends of 1.2 to 2.0 (preferably 1.6 to 1.8), wherein the percentage of saturated chain ends is determined using ¹³C NMR as described in WO 2009/155471 at paragraph [0095] and [0096] except that the spectra are referenced to the chemical shift of the solvent, tetrachloroethane-d₂, and/or a ratio of Mn(GPC)/Mn(¹H NMR) of 0.95 or less (preferably 0.90 or less, preferably 0.85 or less, preferably 0.80 or less);
(iii) optionally, a Tm of greater than 60° C. (preferably greater than 100° C., preferably from 60 to 180° C., preferably from 80 to 175° C.);
(iv) optionally, an Hf of greater than 7 J/g (preferably greater than 15 J/g, greater than 30 J/g, greater than 50 J/g, greater than 60 J/g, or greater than 80 J/g);
(v) optionally, an allyl chain end to internal vinylidene ratio of greater than 5:1 (preferably greater than 10:1);
(vi) optionally, an allyl chain end to vinylidene chain end ratio of greater than 10:1 (preferably greater than 15:1); and
(vii) optionally, an allyl chain end to vinylene chain end ratio of greater than 1:1 (preferably greater than 2:1, greater than 5:1, or greater than 10:1). Such macromonomers and methods to make them are further described in U.S. Ser. No. 13/411,929, filed on Mar. 5, 2012 (published as US ______), which is incorporated in its entirety herein.

### Uses of the Invention

The methods of the invention may be used to recycle waste streams from a process producing PAOs or other vinyl terminated polymers, consuming these low molecular weight vinyl oligomers to produce an oligomer having a higher molecular weight and a higher viscosity than the vinyl terminated oligomer. Accordingly, some embodiments of this invention disclose an integrated process comprising: (i) obtaining a recycle stream comprising one or more vinyl terminated oligomers having a Mn (¹H NMR) of about 150 to about 30,000 g/mol; (ii) contacting the oligomer composition comprising one or more vinyl terminated oligomers with a supported mixed metal oxide catalyst; wherein the contacting causes the reaction of the vinyl terminated oligomers; and obtaining a product having: (i) an Mn (¹H NMR) of about 300 to about 60,000 g/mol, (ii) a higher viscosity than the oligomer composition, (iii) substantially no vinyl chain ends, and (iv) at least one unsaturation internal to the backbone.

In some embodiments of this invention, the recycle stream is fractionated or distilled from the product stream of a polyalphaolefin process. Preferably, the recycle stream comprises vinyl terminated oligomers having a Mn of 30,000 g/mol or less.

In embodiments of this invention, the product oligomer has no vinyl chain ends, and has an unsaturation internal to the backbone of the polymer, which is available for chemical modification via functionalization.

The product oligomers prepared herein may be functionalized by reacting a heteroatom containing group with the oligomer with or without a catalyst. Examples include catalytic hydrosilylation, hydroformylation, or hydroamination, or maleation with activators such as free radical generators (e.g. peroxides). The functionalized oligomers can be used in oil additivation and many other applications. Preferred uses include additives for lubricants and or fuels. Preferred heteroatom containing groups include, amines, aldehydes, alcohols, acids, succinic acid, maleic acid and maleic anhydride.

### EXAMPLES

All reagents and compounds used were purchased from Sigma Aldrich (St. Louis, Mo.) and used as received unless otherwise noted. Cobalt oxide-molybdenum oxide on alumina (3.5% CoO, 14% MoO₃) with a surface area of ˜244 m²/g was purchased from Strem Chemicals (Newburyport, Mass.) and calcined at 500° C. overnight.

All reactions were conducted under an inert atmosphere, such as nitrogen, unless otherwise noted.

### Tests and Materials

Products were characterized by ¹H NMR as follows: ¹H NMR data was collected at either room temperature or 120° C. (for purposes of the claims, 120° C. shall be used) in a 5 mm probe using a Varian spectrometer with a ¹H frequency of at least 400 MHz or a Bruker 500 MHz. Data was recorded using a maximum pulse width of 45°, 8 seconds between pulses and signal averaging 120 transients. Spectral signals were integrated and the number of unsaturation types per 1000 carbons was calculated by multiplying the different groups by 1000 and dividing the result by the total number of carbons. Mₙ of the polymer is determined by ¹H NMR spectroscopy by comparison of integrals of the aliphatic region to the olefin region as determined using the protocol described in the Example section of U.S. Patent Publication No. 2009/0318644 filed on Jun. 20, 2008.

Viscosity measurements were made using a Brookfield digital viscometer. The Brookfield digital viscometer measures the viscosity of liquids at elevated temperature by rotating a sensing element in a fluid and measure the torque necessary to overcome the viscous resistance to the induced movement. This is accomplished by driving a spindle, immersed in the fluid, through a beryllium copper spring. The degree to which the spring is wound, detected by a rotational transducer, is proportional to the viscosity of the fluid. The temperature is controlled by a solid state, triac output, proportioning controller which maintains the spindle, chamber, and sample material at a desired temperature. The system is designed for measuring liquid viscosity over a temperature range of up to 300° C. The lower limit of temperature control is 15° C. above ambient temperature.

### Example 1

### Propylene/Hexene Copolymer (Compound 1)

A 1 L stainless autoclave was charged with 0.5 ml of 1.0 M triisobutylaluminum and 400 mls of isohexanes. Propylene (200 ml) and 1-hexene (100 ml) were added and the reactor was heated to 80° C. A catalyst solution was prepared by combining 3.5 mg of rac-Me₂Si(2-methyl,3-propylindenyl)₂hafnium dimethyl (for preparation of this catalyst, see U.S. Ser. No. 13/072,280) and 7 mg of [PhNHMe₂)[B(C₁₀F₇)₄] (Albemarle, Baton Rouge, La.) in 5 ml toluene. The catalyst solution was stirred at room temperature for 30 minutes and injected into the reactor with high pressure nitrogen. The polymerization was allowed to proceed for 30 minutes at 80° C. and the reactor was then cooled to room temperature. The reactor contents were transferred to a glass vessel and purged with nitrogen for 48 hours. The liquid product was dried in vacuo (70° C., 12 hours) to yield 149 g of Compound 1. The copolymer had 97% vinyls, 3% vinylidenes, and an Mn of 1800 g/mol by ¹H NMR. ¹H NMR (400 MHz, CD₂ClCD₂Cl): 5.78 (m), 5.0 (m), 2.0 (br), 1.8 (br), 1.5 (br), 1.0 (br), 0.8 (m, br).

### Example 2

### Self-Metathesis of a Vinyl Terminated Propylene/Hexene Copolymer

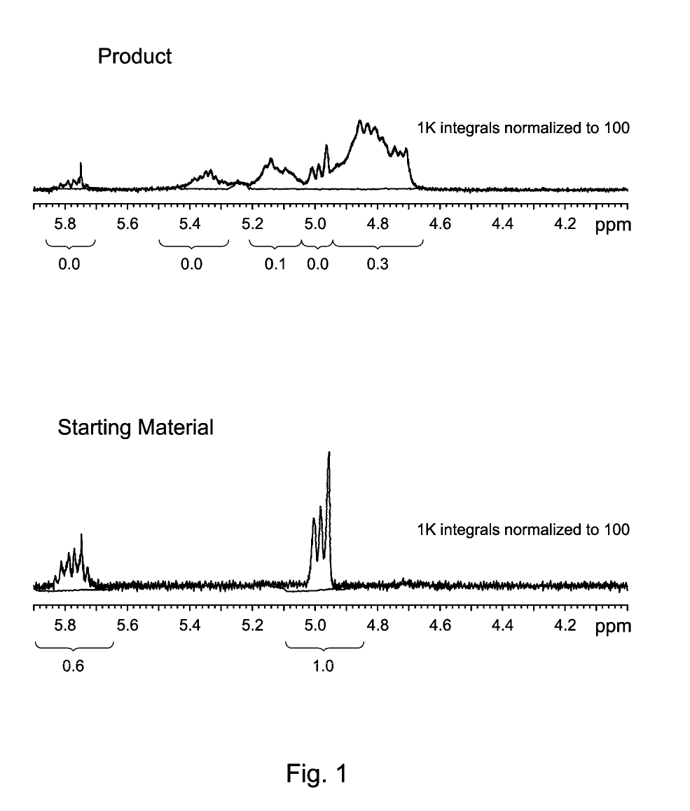

Vinyl terminated propylene/hexene copolymer (10.0 g, Compound 1 from Example 1) was placed in a 50 ml round bottom flask. A 1.0 gram amount of CoO—MoO₃ on alumina (commercially available from Strem, calcined at 500° C., and ground to a fine powder with a mortar and pestle) was added to the reaction mixture and the slurry was heated to 150° C. for 72 hours. After cooling to room temperature, 30 mls of pentane was added to the reaction mixture and the slurry was filtered to remove the heterogeneous catalyst. The filtrate was dried under vacuum yielding a viscous oil (Compound 2). Mn by ¹H NMR integral ratios: 3500 g/mol, 19.4 new olefin/vinyl olefin ratio, 95% conversion, as shown in FIG. 1. ¹H NMR (400 MHz, CD₂ClCD₂Cl): 5.4-4.6 (br), 5.2 (m) 3.5-3.35 (m), 3.25 (br), 3.0 (br), 2.0 (br), 1.57 (br), 1.42 (br), 1.26 (br), 1.02 (br), 0.90 (br), 0.80 (br).

### Example 3

### Self-Metathesis of Vinyl Terminated Propylene Oligomer

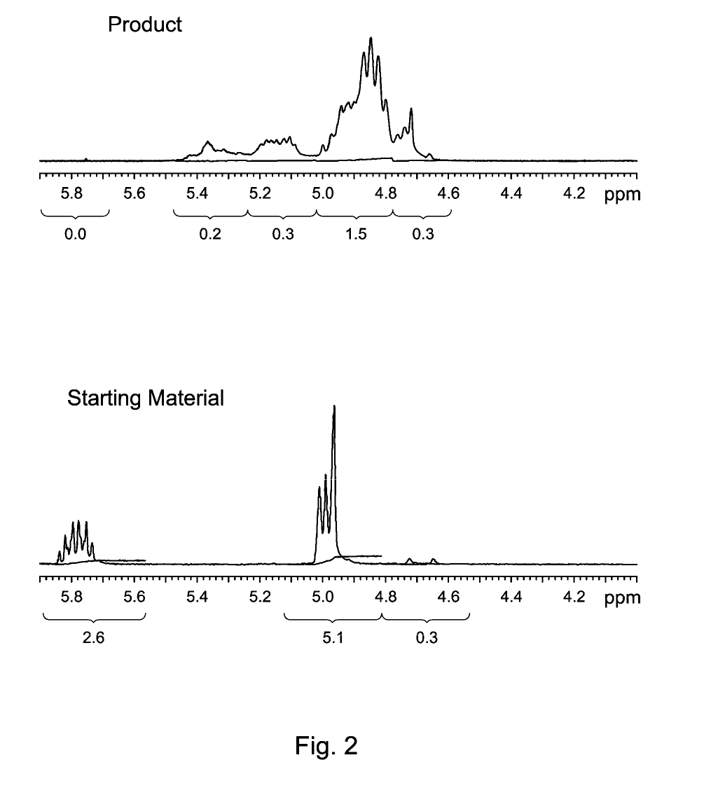

An oven dried 20 mL scintillation vial was charged in a drybox with a stir bar, 400 mg of CoO—MoO₃ on alumina (ground to a fine powder with a mortar and pestle) and 2.1 g of a C₁₅ vinyl terminated polypropylene (Mn (¹H NMR) 210 g/mol, 94.4% vinyls, 5.6% vinylidenes, prepared as disclosed in US 2009/0318644). The mixture was allowed to stir for 20 hours at 120° C. After cooling, the heterogeneous mixture was diluted in pentane and filtered. The pentane was evaporated under a stream of N₂ yielding 1.59 g of a clear, thin oil. Mn by ¹H NMR integral ratios: 595 g/mol with 100% conversion of the vinyl groups as measured by the integration (0%) of the vinyl region 5.7-5.9 ppm, as shown in FIG. 2. ¹H NMR (400 MHz, CD₂ClCD₂Cl): 5.4-4.6 (br), 2.4 (br), 1.9 (br), 1.65 (s, br), 1.57 (s, br), 1.26 (br), 1.02 (br), 0.85 (br).

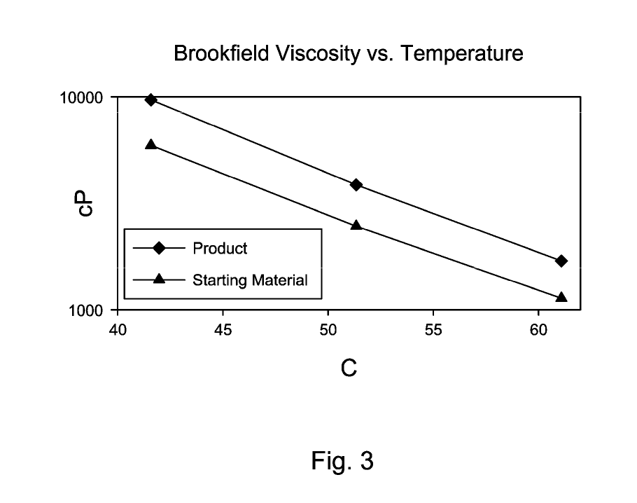

The viscosity of the polymers from Examples 1 to 2 was measured using a Brookfield viscometer at various temperatures. The results are shown in Table 1, below and in FIG. 3.

TABLE 1
Viscosity of Examples 1 to 2

| | | Spindle | Temperature | % | Spindle | Viscosity |
|---|---|---|---|---|---|---|
| Example | RPM | # | (° C.) | Torque | Factor | (cP) |
| 2 | 100 | 21 | 41.7 | 76.6 | 5 | 383 |
| 2 | 100 | 21 | 51.5 | 29.9 | 5 | 149.5 |
| 2 | 100 | 21 | 61.3 | 13.3 | 5 | 66.5 |
| 1 | 100 | 21 | 41.7 | 46.5 | 5 | 232.5 |
| 1 | 100 | 21 | 51.5 | 19.3 | 5 | 96.5 |
| 1 | 100 | 21 | 61.3 | 8.9 | 5 | 44.5 |

Table 1 shows an increase in viscosity at each temperature point, when comparing Example 2 (metathesis product) to Example 1 (vinyl terminated oligomer). For the purpose of the claims, viscosity is measured at about 40° C.

Other embodiments of this invention relate to:

1. A processes for increasing the viscosity of an oligomer composition by:
contacting (at a temperature of 20° C. to 300° C. (preferably 20° C. to 200° C., preferably 30° C. to 100° C., preferably 40° C. to 60° C.) and/or a pressure of 0.1 psig to 1000 psi (0.7 kPa to 6.9 MPa) (preferably 20 psi to 400 psi (0.14 MPa to 2.8 MPa), preferably 50 psi to 250 psi (0.34 MPa to 1.7 MPa)), and/or for a residence time of 0.5 seconds to 96 hours (preferably 0.25 to 72 hours, preferably 30 minutes to 24 hours)) the oligomer composition comprising one or more vinyl terminated oligomers (preferably, the vinyl terminated oligomer has any of (i) an Mn (¹H NMR) of less than 30,000 g/mol; (ii) a Mw/Mn in the range of from 1.5 to 20 (preferably from 1.7 to 10, more preferably from 1.7 to 5; (iii) at least 5% ally chain ends, relative to total unsaturations (preferably at least 50% allyl chain ends)); with a supported mixed metal oxide catalyst (preferably supported on alumina, silica, calcium oxide, magnesium oxide, or combinations thereof);
wherein the contacting causes the reaction of the vinyl terminated oligomers; and
producing a product having (1) a higher viscosity (preferably at least 5% higher, at least 15%, 25%, 50%, 75%, or 85% higher), measured at 40° C., than the oligomer composition; (2) optionally, an Mn that is about 1.8 to 2.2 times (preferably 2.0 times) that of the oligomer composition; (3) optionally, an Mn (¹H NMR) of from about 300 to about 60,000 g/mol; (4) optionally, 0% allyl chain ends; (5) optionally an unsaturation internal to the backbone; and (6) a MWD is in the range of from about 1.1 to about 2.5 (preferably about 1.1 to 2.0, and more preferably about 1.1 to 1.5).
2. The processes of paragraph 1, wherein the supported mixed metal oxide catalyst comprises two or more of cobalt oxide, a molybdenum oxide, rhenium oxide, tungsten oxide, vanadium oxide, boron oxide, and mixtures thereof (preferably the supported mixed metal oxide catalyst comprises one or more of CoO/MoO₃, Re₂O₇/Al₂O₃, Re₂O₇/SiO₂/Al₂O₃, Re₂O₇/Al₂O₃/V₂O₅, WO₃/MgO, and WO₃/SiO₂; most preferably CoO/MoO₃) and optionally, comprises one or more elements selected from the group consisting of Na, S, Si, Mg, B, Ba, Zn, Sb, and W (preferably one or more elements selected from the group consisting of Na, Si, Mg, B, Zn, Sb, and W).
3. The processes of paragraphs 1 and 2, wherein the supported mixed metal oxide is calcined, preferably at a temperature in the range of 200° C. to 1200° C., more preferably at a temperature in the range of 450° C. to 650° C.
4. The processes of paragraphs 1 to 3, further comprising contacting the catalyst with an activator (preferably, the activator is a tetraalkyltin compound; preferably tetramethyltin).
5. The processes of paragraphs 1 to 4, wherein the vinyl terminated oligomer composition is a recycle stream from a polyalphaolefin process.
6. The processes of paragraph 1 to 5, wherein the vinyl terminated oligomer is one or more of:
(i) a vinyl terminated polymer having an Mn of at least 200 g/mol (measured by ¹H NMR) comprising of one or more C₄ to C₄₀ derived units, where polymer comprises substantially no propylene derived units; and wherein the polymer has at least 5% allyl chain ends;
(ii) a copolymer having an Mn of 300 g/mol or more (measured by ¹H NMR) comprising (a) from about 20 mol % to about 99.9 mol % of at least one C₅ to C₄₀ higher olefin, and (b) from about 0.1 mol % to about 80 mol % of propylene, wherein the higher olefin copolymer has at least 40% allyl chain ends;
(iii) a copolymer having an Mn of 300 g/mol or more (measured by ¹H NMR), and comprises (a) from about 80 mol % to about 99.9 mol % of at least one C₄ olefin, (b) from about 0.1 mol % to about 20 mol % of propylene; and wherein the vinyl terminated macromonomer has at least 40% allyl chain ends relative to total unsaturation;
(iv) a co-oligomer having an Mn of 300 g/mol to 30,000 g/mol (measured by ¹H NMR) comprising 10 mol % to 90 mol % propylene and 10 mol % to 90 mol % of ethylene, wherein the oligomer has at least X % allyl chain ends (relative to total unsaturations), where: 1) X=(−0.94*(mol % ethylene incorporated)+100), when 10 mol % to 60 mol % ethylene is present in the co-oligomer, 2) X=45, when greater than 60 mol % and less than 70 mol % ethylene is present in the co-oligomer, and 3) X=(1.83*(mol % ethylene incorporated)−83), when 70 mol % to 90 mol % ethylene is present in the co-oligomer (preferably the vinyl terminated oligomer is a co-oligomer having an Mn of 300 to 30,000 g/mol (measured by ¹H NMR) comprising 50 mol % to 90 mol % propylene and 10 mol % to 50 mol % of ethylene, wherein the co-oligomer has at least X % allyl chain ends (relative to total unsaturations), where: X=(−0.94*(mol % ethylene incorporated)+100));
(v) a propylene oligomer, comprising more than 90 mol % propylene and less than 10 mol % ethylene wherein the oligomer has: at least 93% allyl chain ends, a number average molecular weight (Mn) of about 500 g/mol to about 20,000 g/mol, an isobutyl chain end to allylic vinyl group ratio of 0.8:1 to 1.35:1.0, and less than 100 ppm aluminum;
(vi) a propylene oligomer, comprising: at least 50 mol % propylene and from 10 mol % to 50 mol % ethylene, wherein the oligomer has: at least 90% allyl chain ends, an Mn of about 150 g/mol to about 10,000 g/mol, and an isobutyl chain end to allylic vinyl group ratio of 0.8:1 to 1.2:1.0, wherein monomers having four or more carbon atoms are present at from 0 mol % to 3 mol %;
(vii) a propylene oligomer, comprising: at least 50 mol % propylene, from 0.1 mol % to 45 mol % ethylene, and from 0.1 mol % to 5 mol % C₄ to C₁₂ olefin, wherein the oligomer has: at least 90% allyl chain ends, an Mn of about 150 g/mol to about 10,000 g/mol, and an isobutyl chain end to allylic vinyl group ratio of 0.8:1 to 1.35:1.0;
(viii) a propylene oligomer, comprising: at least 50 mol % propylene, from 0.1 mol % to 45 mol % ethylene, and from 0.1 mol % to 5 mol % diene, wherein the oligomer has: at least 90% allyl chain ends, an Mn of about 150 g/mol to about 10,000 g/mol, and an isobutyl chain end to allylic vinyl group ratio of 0.7:1 to 1.35:1.0;
(ix) a homo-oligomer, comprising propylene, wherein the oligomer has: at least 93% allyl chain ends, an Mn of about 500 g/mol to about 20,000 g/mol, an isobutyl chain end to allylic vinyl group ratio of 0.8:1 to 1.2:1.0, and less than 1400 ppm aluminum (preferably a homo-oligomer, comprising propylene and 0 wt % comonomer, wherein the homo-oligomer has: at least 95% allyl chain ends, an Mn of about 700 to about 10,000 g/mol, an isobutyl chain end to allylic vinyl group ratio of 0.8:1 to 1.2:1.0, and less than 1400 ppm aluminum);
(x) a copolymer having an Mn (¹H NMR) of 7,500 to 60,000 g/mol comprising one or more alpha olefin derived units comprising ethylene and/or propylene, and having 50% or greater allyl chain ends, relative to total number of unsaturated chain ends and a g′ of 0.90 or less;
(xi) a branched polyolefin having an Mn (GPC) greater than 60,000 g/mol comprising one or more alpha olefins comprising ethylene and/or propylene, and having: (i) 50% or greater allyl chain ends, relative to total unsaturated chain ends; (ii) a g′vis of 0.90 or less; and optionally; and (iii) a bromine number which, upon complete hydrogenation, decreases by at least 50%; and
(xii) a branched polyolefin having an Mn (¹H NMR) of less than 7,500 g/mol comprising one or more alpha olefin derived units comprising ethylene and/or propylene, and having: a ratio of percentage of saturated chain ends to percentage of allyl chain ends of 1.2 to 2.0; and 50% or greater allyl chain ends, relative to total moles of unsaturated chain ends.
   7. The processes of paragraph 1 to 6, wherein the vinyl terminated oligomer is a co-oligomer having an Mn of 300 to 30,000 g/mol (measured by ¹H NMR) and an Mw/Mn by GPC-DRI of 1.5 to 20 comprising 10 mol % to 90 mol % propylene and 10 mol % to 90 mol % of ethylene, wherein the co-oligomer has at least X % allyl chain ends (relative to total unsaturations), where: 1) X=(−0.94*(mol % ethylene incorporated)+100), when 10 mol % to 60 mol % ethylene is present in the co-oligomer, and 2) X=45, when greater than 60 mol % and less than 70 mol % ethylene is present in the co-oligomer, and 3) X=(1.83*(mol % ethylene incorporated)−83), when 70 mol % to 90 mol % ethylene is present in the co-oligomer, and wherein the co-oligomer has an isobutyl chain end to allylic vinyl group ratio of 0.8:1 to 1.35:1.0.
   8. The integrated processes of paragraph 1 to 7, comprising:
(i) obtaining a recycle stream comprising one or more vinyl terminated oligomers having a Mn (¹H NMR) of about 150 to about 30,000 g/mol (preferably, the recycle stream is fractionated or distilled from a product stream of a polyalphaolefin process);
(ii) contacting the oligomer composition comprising one or more vinyl terminated oligomers with a supported mixed metal oxide catalyst; wherein the contacting causes the reaction of the vinyl terminated oligomers; and
(iii) obtaining a product having: (1) an Mn (¹H NMR) of about 300 to about 60,000 g/mol, (2) a higher viscosity than the oligomer composition, (3) 0% allyl chain ends, and (4) at least one unsaturation internal to the backbone.
   9. A lubricant made by the processes of paragraphs 1 to 8.

All documents described herein are incorporated by reference herein, including any priority documents and/or testing procedures to the extent they are not inconsistent with this text, provided however that any priority document not named in the initially filed application or filing documents is NOT incorporated by reference herein. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law. Likewise, “comprising” encompasses the terms “consisting essentially of,” “is,” and “consisting of” and anyplace “comprising” is used “consisting essentially of,” “is,” or “consisting of” may be substituted therefor.

What is claimed is:

1. A process for increasing the viscosity of an oligomer composition by:
contacting the oligomer composition comprising one or more vinyl terminated oligomers with a supported mixed metal oxide catalyst;
wherein the contacting causes the reaction of the vinyl terminated oligomers; and
producing a product having a higher viscosity, measured at 40° C., than the oligomer composition.

2. The process of claim 1, wherein the vinyl terminated oligomer has an Mn (¹H NMR) of less than 30,000 g/mol.

3. The process of claim 1, wherein the product has an Mn (¹H NMR) of from about 300 to about 60,000 g/mol.

4. The process of claim 1, wherein the supported mixed metal oxide catalyst is supported on alumina, silica, calcium oxide, magnesium oxide, or combinations thereof.

5. The process of claim 1, wherein the supported mixed metal oxide catalyst comprises two or more of cobalt oxide, a molybdenum oxide, rhenium oxide, tungsten oxide, vanadium oxide, boron oxide, and mixtures thereof.

6. The process of claim 1, wherein the supported mixed metal oxide catalyst comprises one or more of CoO/MoO₃, Re₂O₇/Al₂O₃, Re₂O₇/SiO₂/Al₂O₃, Re₂O₇/Al₂O₃/V₂O₅, WO₃/MgO, and WO₃/SiO₂.

7. The process of claim 1, wherein the supported mixed metal oxide catalyst is CoO/MoO₃.

8. The process of claim 1, wherein the supported mixed metal oxide catalyst comprises one or more elements selected from the group consisting of Na, S, Si, Mg, B, Ba, Zn, Sb, and W.

9. The process of claim 8, wherein the supported mixed metal oxide catalyst comprises one or more elements selected from the group consisting of Na, Si, Mg, B, Zn, Sb, and W.

10. The process of claim 1, wherein the supported mixed metal oxide is calcined.

11. The process of claim 1, wherein the supported mixed metal oxide catalyst is calcined at a temperature in the range of 200° C. to 1200° C.

12. The process of claim 1, wherein the supported mixed metal oxide catalyst is calcined at a temperature in the range of 450° C. to 650° C.

13. The process of claim 1, further comprising contacting the catalyst with an activator.

14. The process of claim 13, wherein the activator is a tetraalkyltin compound.

15. The process of claim 1, wherein the vinyl terminated oligomer composition is a recycle stream from a polyalphaolefin process.

16. The process of claim 1, wherein the vinyl terminated oligomer has at least 50% allyl chain ends, relative to total unsaturations.

17. The process of claim 1, wherein the vinyl terminated oligomer is one or more of:
(i) a vinyl terminated polymer having an Mn of at least 200 g/mol (measured by ¹H NMR) comprising of one or more C₄ to C₄₀ derived units, where polymer comprises substantially no propylene derived units; and wherein the polymer has at least 5% allyl chain ends;
(ii) a copolymer having an Mn of 300 g/mol or more (measured by ¹H NMR) comprising (a) from about 20 mol % to about 99.9 mol % of at least one C₅ to C₄₀ higher olefin, and (b) from about 0.1 mol % to about 80 mol % of propylene, wherein the higher olefin copolymer has at least 40% allyl chain ends;
(iii) a copolymer having an Mn of 300 g/mol or more (measured by ¹H NMR), and comprises (a) from about 80 mol % to about 99.9 mol % of at least one C₄ olefin, (b) from about 0.1 mol % to about 20 mol % of propylene; and wherein the vinyl terminated macromonomer has at least 40% allyl chain ends relative to total unsaturation;
(iv) a co-oligomer having an Mn of 300 g/mol to 30,000 g/mol (measured by ¹H NMR) comprising 10 mol % to 90 mol % propylene and 10 mol % to 90 mol % of ethylene, wherein the oligomer has at least X % allyl chain ends (relative to total unsaturations), where: 1) X=(−0.94*(mol % ethylene incorporated)+100), when 10 mol % to 60 mol % ethylene is present in the co-oligomer, 2) X=45, when greater than 60 mol % and less than 70 mol % ethylene is present in the co-oligomer, and 3) X=(1.83*(mol % ethylene incorporated)−83), when 70 mol % to 90 mol % ethylene is present in the co-oligomer;
(v) a propylene oligomer, comprising more than 90 mol % propylene and less than 10 mol % ethylene wherein the oligomer has: at least 93% allyl chain ends, a number average molecular weight (Mn) of about 500 g/mol to about 20,000 g/mol, an isobutyl chain end to allylic vinyl group ratio of 0.8:1 to 1.35:1.0, and less than 100 ppm aluminum;
(vi) a propylene oligomer, comprising: at least 50 mol % propylene and from 10 mol % to 50 mol % ethylene, wherein the oligomer has: at least 90% allyl chain ends, an Mn of about 150 g/mol to about 10,000 g/mol, and an isobutyl chain end to allylic vinyl group ratio of 0.8:1 to 1.2:1.0, wherein monomers having four or more carbon atoms are present at from 0 mol % to 3 mol %;
(vii) a propylene oligomer, comprising: at least 50 mol % propylene, from 0.1 mol % to 45 mol % ethylene, and from 0.1 mol % to 5 mol % C₄ to C₁₂ olefin, wherein the oligomer has: at least 90% allyl chain ends, an Mn of about 150 g/mol to about 10,000 g/mol, and an isobutyl chain end to allylic vinyl group ratio of 0.8:1 to 1.35:1.0;
(viii) a propylene oligomer, comprising: at least 50 mol % propylene, from 0.1 mol % to 45 mol % ethylene, and from 0.1 mol % to 5 mol % diene, wherein the oligomer has: at least 90% allyl chain ends, an Mn of about 150 g/mol to about 10,000 g/mol, and an isobutyl chain end to allylic vinyl group ratio of 0.7:1 to 1.35:1.0;
(ix) a homo-oligomer, comprising propylene, wherein the oligomer has: at least 93% allyl chain ends, an Mn of about 500 g/mol to about 20,000 g/mol, an isobutyl chain end to allylic vinyl group ratio of 0.8:1 to 1.2:1.0, and less than 1400 ppm aluminum;
(x) a copolymer having an Mn (¹H NMR) of 7,500 to 60,000 g/mol comprising one or more alpha olefin derived units comprising ethylene and/or propylene, and having 50% or greater allyl chain ends, relative to total number of unsaturated chain ends and a g′vis of 0.90 or less;
(xi) a branched polyolefin having an Mn (GPC) greater than 60,000 g/mol comprising one or more alpha olefins comprising ethylene and/or propylene, and having: (i) 50% or greater allyl chain ends, relative to total unsaturated chain ends; (ii) a g′vis of 0.90 or less; and optionally; and (iii) a bromine number which, upon complete hydrogenation, decreases by at least 50%; and
(xii) a branched polyolefin having an Mn (¹H NMR) of less than 7,500 g/mol comprising one or more alpha olefin derived units comprising ethylene and/or propylene, and having: a ratio of percentage of saturated chain ends to percentage of allyl chain ends of 1.2 to 2.0; and 50% or greater allyl chain ends, relative to total moles of unsaturated chain ends.

18. The process of claim 1, wherein the viscosity of the product is at least 5% higher than the viscosity of the oligomer composition.

19. The process of claim 1, wherein the Mn of the product is from about 0.8 to about 1.2 times that of the oligomer composition.

20. The process of claim 1, wherein the product oligomer has an unsaturation internal to the backbone.

21. The process of claim 1, wherein the product oligomer has 0% allyl chain ends.

22. The process of claim 1, wherein the contacting occurs at a temperature in the range of from about 20 to about 150° C., and/or a pressure in the range of from about 0.7 kPa to 6.9 MPa, and/or a time in the range of from about 0.5 to 96 hours.

23. The process of claim 1, wherein the vinyl terminated oligomer is a co-oligomer having an Mn of 300 to 30,000 g/mol (measured by ¹H NMR) comprising 50 mol % to 90 mol % propylene and 10 mol % to 50 mol % of ethylene, wherein the co-oligomer has at least X % allyl chain ends (relative to total unsaturations), where: X=(−0.94*(mol % ethylene incorporated)+100).

24. The process of claim 1, wherein the vinyl terminated oligomer is a co-oligomer having an Mn of 300 to 30,000 g/mol (measured by ¹H NMR) and an Mw/Mn by GPC-DRI of 1.5 to 20 comprising 10 mol % to 90 mol % propylene and 10 mol % to 90 mol % of ethylene, wherein the co-oligomer has at least X % allyl chain ends (relative to total unsaturations), where: 1) X=(−0.94*(mol % ethylene incorporated)+100), when 10 mol % to 60 mol % ethylene is present in the co-oligomer, and 2) X=45, when greater than 60 mol % and less than 70 mol % ethylene is present in the co-oligomer, and 3) X=(1.83*(mol % ethylene incorporated)−83), when 70 mol % to 90 mol % ethylene is present in the co-oligomer, and wherein the co-oligomer has an isobutyl chain end to allylic vinyl group ratio of 0.8:1 to 1.35:1.0.

25. The process of claim 1, wherein the vinyl terminated oligomer is a homo-oligomer, comprising propylene and 0 wt % comonomer, wherein the homo-oligomer has: at least 95% allyl chain ends, an Mn of about 700 to about 10,000 g/mol, an isobutyl chain end to allylic vinyl group ratio of 0.8:1 to 1.2:1.0, and less than 1400 ppm aluminum.

26. The process of claim 1, wherein the vinyl terminated oligomer is a liquid at 25° C.

27. An integrated process comprising:
(i) obtaining a recycle stream comprising one or more vinyl terminated oligomers having a Mn (¹H NMR) of about 150 to about 30,000 g/mol;
(ii) contacting the oligomer composition comprising one or more vinyl terminated oligomers with a supported mixed metal oxide catalyst; wherein the contacting causes the reaction of the vinyl terminated oligomers; and
(iii) obtaining a product having: (1) an Mn (¹H NMR) of about 300 to about 60,000 g/mol, (2) a higher viscosity than the oligomer composition, (3) 0% allyl chain ends, and (4) at least one unsaturation internal to the backbone.

28. The process of claim 27, wherein the vinyl terminated oligomer is a liquid at 25° C.

29. The process of claim 27, wherein the vinyl terminated oligomer is one or more of:
(i) a vinyl terminated polymer having an Mn of at least 200 g/mol (measured by ¹H NMR) comprising of one or more C₄ to C₄₀ derived units, where polymer comprises substantially no propylene derived units; and wherein the polymer has at least 5% allyl chain ends;
(ii) a copolymer having an Mn of 300 g/mol or more (measured by ¹H NMR) comprising (a) from about 20 mol % to about 99.9 mol % of at least one C₅ to C₄₀ higher olefin, and (b) from about 0.1 mol % to about 80 mol % of propylene, wherein the higher olefin copolymer has at least 40% allyl chain ends;
(iii) a copolymer having an Mn of 300 g/mol or more (measured by ¹H NMR), and comprises (a) from about 80 mol % to about 99.9 mol % of at least one C₄ olefin, (b) from about 0.1 mol % to about 20 mol % of propylene; and wherein the vinyl terminated macromonomer has at least 40% allyl chain ends relative to total unsaturation;
(iv) a co-oligomer having an Mn of 300 g/mol to 30,000 g/mol (measured by ¹H NMR) comprising 10 mol % to 90 mol % propylene and 10 mol % to 90 mol % of ethylene, wherein the oligomer has at least X % allyl chain ends (relative to total unsaturations), where: 1) X=(−0.94*(mol % ethylene incorporated)+100), when 10 mol % to 60 mol % ethylene is present in the co-oligomer, 2) X=45, when greater than 60 mol % and less than 70 mol % ethylene is present in the co-oligomer, and 3) X=(1.83*(mol % ethylene incorporated)−83), when 70 mol % to 90 mol % ethylene is present in the co-oligomer;
(v) a propylene oligomer, comprising more than 90 mol % propylene and less than 10 mol % ethylene wherein the oligomer has: at least 93% allyl chain ends, a number average molecular weight (Mn) of about 500 g/mol to about 20,000 g/mol, an isobutyl chain end to allylic vinyl group ratio of 0.8:1 to 1.35:1.0, and less than 100 ppm aluminum;
(vi) a propylene oligomer, comprising: at least 50 mol % propylene and from 10 mol % to 50 mol % ethylene, wherein the oligomer has: at least 90% allyl chain ends, an Mn of about 150 g/mol to about 10,000 g/mol, and an isobutyl chain end to allylic vinyl group ratio of 0.8:1 to 1.2:1.0, wherein monomers having four or more carbon atoms are present at from 0 mol % to 3 mol %;
(vii) a propylene oligomer, comprising: at least 50 mol % propylene, from 0.1 mol % to 45 mol % ethylene, and from 0.1 mol % to 5 mol % C₄ to C₁₂ olefin, wherein the oligomer has: at least 90% allyl chain ends, an Mn of about 150 g/mol to about 10,000 g/mol, and an isobutyl chain end to allylic vinyl group ratio of 0.8:1 to 1.35:1.0;
(viii) a propylene oligomer, comprising: at least 50 mol % propylene, from 0.1 mol % to 45 mol % ethylene, and from 0.1 mol % to 5 mol % diene, wherein the oligomer has: at least 90% allyl chain ends, an Mn of about 150 g/mol to about 10,000 g/mol, and an isobutyl chain end to allylic vinyl group ratio of 0.7:1 to 1.35:1.0;
(ix) a homo-oligomer, comprising propylene, wherein the oligomer has: at least 93% allyl chain ends, an Mn of about 500 g/mol to about 20,000 g/mol, an isobutyl chain end to allylic vinyl group ratio of 0.8:1 to 1.2:1.0, and less than 1400 ppm aluminum;
(x) a copolymer having an Mn (¹H NMR) of 7,500 to 60,000 g/mol comprising one or more alpha olefin derived units comprising ethylene and/or propylene, and having 50% or greater allyl chain ends, relative to total number of unsaturated chain ends and a g′vis of 0.90 or less;
(xi) a branched polyolefin having an Mn (GPC) greater than 60,000 g/mol comprising one or more alpha olefins comprising ethylene and/or propylene, and having: (i) 50% or greater allyl chain ends, relative to total unsaturated chain ends; (ii) a g′vis of 0.90 or less; and optionally; and (iii) a bromine number which, upon complete hydrogenation, decreases by at least 50%; and
(xii) a branched polyolefin having an Mn (¹H NMR) of less than 7,500 g/mol comprising one or more alpha olefin derived units comprising ethylene and/or propylene, and having: a ratio of percentage of saturated chain ends to percentage of allyl chain ends of 1.2 to 2.0; and 50% or greater allyl chain ends, relative to total moles of unsaturated chain ends.

30. The process of claim 27, wherein the contacting occurs at a temperature in the range of from about 20° C. to about 150° C., and/or a pressure in the range of from about 0.7 kPa to 6.9 MPa, and/or a time in the range of from about 0.5 to 96 hours.

31. The process of claim 27, wherein the recycle stream is fractionated or distilled from a product stream of the polyalphaolefin process.
